(19) United States
(12) Patent Application Publication
(10) Pub. No.: US 2008/0079795 A1
(43) Pub. Date: Apr. 3, 2008

(54) INKJET RECORDING APPARATUS

(75) Inventor: Yusuke NAKAZAWA, Shizuoka (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 11/859,808

(22) Filed: Sep. 24, 2007

(30) Foreign Application Priority Data
Sep. 29, 2006 (JP) 2006-269001

(51) Int. Cl. B41J 2/01

(52) U.S. Cl. 347/102

(57) ABSTRACT

An inkjet recording apparatus includes: an inkjet head that ejects an active energy-curable ink to form an image on a recording medium; an irradiating unit that includes a light source, and that irradiates an active energy ray from the light source to cure the active energy-curable ink ejected by the inkjet head; an energy intensity measuring unit that measures an intensity value of the active energy ray irradiated on the recording medium; and an irradiation condition control unit that controls an irradiation condition of the active energy ray on the recording medium on the basis of the intensity value measured by the energy intensity measuring unit after a passing of time to the extent of allowing the temperature of the irradiating unit to be stabilized at the start-up from lighting or rest of the irradiating unit.

### BACKGROUND OF THE INVENTION

1. Field of the Invention

The present invention relates to an inkjet recording apparatus for performing the image recording on a recording medium by irradiating an active energy and thereby curing an active energy-curable ink ejected on the recording medium by an inkjet head.

2. Background Art

In recent years, there have been proposed various types of an active energy curing-type inkjet recording apparatus where ink drops of an active energy-curable ink capable of being cured upon irradiation of an active energy such as electron beam and ultraviolet ray are ejected on a recording medium by an inkjet head and the ejected ink is cured by irradiating an active energy, thereby performing image recording on the recording medium.

As compared with a general inkjet recording apparatus not using an active energy-curable ink, this active energy curing-type inkjet recording apparatus is advantageous in various points, for example, high-speed recording on various recording mediums can be realized utilizing the quality of the active energy-curable ink itself, a high-resolution image with less blurring can be recorded, and the system is environment-friendly.

Above all, development of an apparatus using an ultraviolet-curable ink is proceeding in view of easy handling of the light source, compactness and the like. Particularly, the utility of a so-called single-path inkjet recording apparatus is expected, where by taking advantage of high-speed fixing of the ultraviolet-curable ink, a recording medium in the form of a web allowing for high-speed conveyance is used and in the state that a recording head capable of performing the recording in the full width of a recording medium is fixed, the recording is completed by passing the recording medium only once under the recording head.

Meanwhile, in the inkjet printer employing a photocuring-type inkjet system, light from the light source is sometimes not uniformly radiated due to attachment of ink mist or foreign matters such as dust to the light source during the recording operation or the like. In this case, a portion not subjected to light of the irradiation energy is generated and good image recording cannot be performed. Particularly, when an illuminance reduction site extremely decreased in the illuminance to fail in satisfying the specified illuminance is present in a part of the light source, some ink drops landed cannot be sufficiently subjected to light of the irradiation energy and the ink may not be successfully cured. Also, when an ultraviolet light source is used as the light source, the life of the light source is short and the intensity decreases in aging. In this case, the light of the irradiation energy is not sufficiently applied and good image recording cannot be performed.

The inkjet printer disclosed, for example, in JP-A-2005-246955 (the term “JP-A” as used herein means an “unexamined published Japanese patent application”) is intended to overcome such troubles. In this inkjet printer, the image recording part where a recording medium (sheet such as cut paper) having a predetermined length in the conveying direction is fed from the conveyance inlet of a casing and after conveyance through the casing, conveyed to the outside, comprises an illuminance detection mechanism for detecting the illuminance of light irradiated from a light irradiating device, and a control device capable of changing the irradiation energy of light irradiated on the ink based on the illuminance detection results, so that the ink can be successfully cured by controlling the irradiation energy.

However, in the single-path inkjet recording apparatus using a recording medium in the form of a web allowing for high-speed conveyance, the lengthy rolled paper after unrolled from the conveyance-side roll and passed through the image recording part is taken up by the takeup-side roll, and the active energy irradiating part is in the state of being always covered by the web-like recording medium, as a result, the illuminance detection mechanism cannot function at the position where the illuminance detection is disposed in the case of sheet conveyance recording. When the illuminance detection mechanism is disposed in the vicinity of the active energy irradiating part, the characteristics of the illuminance detection mechanism are changed due to elevation of the temperature. Thus, there is no effective measuring means for stably measuring the intensity of the irradiated active energy.

### SUMMARY OF THE INVENTION

The present invention has been made under these circumstances, and an object of the present invention is to provide an active energy curing-type inkjet recording apparatus, which is an apparatus for performing image recording on a web-like recording medium, ensuring that the ink can be cured by irradiating an energy thereon with a stable intensity of the irradiated active energy, and thereby enable maintaining high-quality image recording over a long period of time and in turn elevating the productivity.

The above-described object of the present invention can be attained by the following constructions.

(1) An inkjet recording apparatus includes: an inkjet head that ejects an active energy-curable ink to form an image on a recording medium; an irradiating unit that includes a light source, and that irradiates an active energy ray from the light source to cure the active energy-curable ink ejected by the inkjet head; an energy intensity measuring unit that measures an intensity value of the active energy ray irradiated on the recording medium; and an irradiation condition control unit that controls an irradiation condition of the active energy ray on the recording medium on the basis of the intensity value measured by the energy intensity measuring unit after a passing of time to the extent of allowing the temperature of the irradiating unit to be stabilized at the start-up from lighting or rest of the irradiating unit.

According to this active energy curing-type inkjet recording apparatus, the energy intensity is measured by the energy intensity measuring means after the passing of time to the extent of allowing the temperature of the active energy irradiating means to be stabilized at the start-up from lighting or rest of the active energy irradiating means, so that fluctuation in the measurement results based on the temperature characteristics of the energy intensity measuring means can be suppressed and the energy intensity can be stably measured.

Also, the irradiation condition control means controls the irradiation conditions of the active energy on the recording medium based on the measured energy intensity value measured by the energy intensity measuring means after the passing of time to the extent of allowing the temperature of the active energy irradiating to be stabilized, so that a high-quality image can be formed by stably irradiating an energy with a predetermined energy intensity on the active energy-curable ink.

### (2) The inkjet recording apparatus as described in the item (1), wherein the active energy ray is an ultraviolet ray, and the energy intensity measuring unit comprises a light intensity measuring unit.

According to this active energy curing-type inkjet recording apparatus, the active energy is an ultraviolet ray and the energy intensity measuring means is light intensity measuring means, so that the apparatus can be advantageous in terms of easy handling of the light source and compactness and the light intensity can be easily measured. Furthermore, a UV-curable ink can be used and this enables high-speed fixing, as a result, high-speed conveyance of a recording medium, that is, high-speed recording can be realized.

### (3) The inkjet recording apparatus as described in the item (2), wherein the light source of the irradiating unit comprises an ultrahigh-pressure mercury lamp.

According to this active energy curing-type inkjet recording apparatus, the active energy irradiating means is a mercury lamp, so that an inexpensive, compact and easily handleable light source can be obtained.

According to the active energy curing-type inkjet recording apparatus of the present invention, the energy intensity is measured by the energy intensity measuring means after the passing of time to the extent of allowing the temperature of the active energy irradiating means to be stabilized at the start-up from lighting or rest of the active energy irradiating means, and the irradiation condition control means controls the irradiation conditions of the active energy on the recording medium based on the measured energy intensity value, so that the fluctuation in the measurement results based on the temperature characteristics of the energy intensity measuring means can be suppressed and the energy intensity can be stably measured. In turn, high-quality image recording can be maintained over a long period of time by stably irradiating an energy with a predetermined energy intensity on an active energy-curable ink and the productivity of image recording can be enhanced.

### BRIEF DESCRIPTION OF THE DRAWINGS

The invention disclosed herein will be understood better with reference to the following drawings of which:

FIG. 1 is a schematic construction view of the active energy curing-type inkjet recording apparatus according to the first embodiment of the present invention;

FIG. 2 is an enlarged perspective view of the ultrahigh-pressure mercury lamp equipped in the active energy curing-type inkjet recording apparatus shown in FIG. 1;

FIG. 3 is a perspective view of segment separating means equipped in the active energy curing-type inkjet recording apparatus shown in FIG. 1;

FIGS. 4A and 4B are a perspective view and a side view, respectively, of the light guiding part equipped in the active energy curing-type inkjet recording apparatus shown in FIG. 1;

FIG. 5 is a block diagram of the control means;

FIG. 6 is a flow chart showing one example of the procedure in the drive control method;

FIG. 7 is a graph showing the correlation between the lighting elapsed time and the illuminance of the light intensity sensor;

FIG. 8 is a construction view of the light intensity sensor equipped with a temperature sensor;

FIG. 9 is a schematic construction view of the active energy curing-type inkjet recording apparatus according to the second embodiment;

FIG. 10 is an enlarged perspective view of the conveyance path changing means and the sensor station shown in FIG. 9;

FIGS. 11A to 11D are operation explanatory views where one example of the active energy detecting step for the active energy irradiating part is shown;

FIG. 12 is a schematic construction view of the active energy curing-type inkjet recording apparatus in the embodiment of face-to-face position;

FIG. 13 is a perspective view when the sensor station shown in FIG. 12 is viewed from above;

FIGS. 14A and 14B are operation explanatory views of the active energy curing-type inkjet recording apparatus shown in FIG. 12;

FIG. 15 is a graph showing the correlation between the lighting elapsed time and the temperature of the active energy irradiating part; and

FIG. 16 is a graph showing the correlation between the temperature and the sensor output of the light intensity sensor.

### DETAILED DESCRIPTION OF THE INVENTION

Preferred embodiments of the active energy curing-type inkjet recording apparatus of the present invention each is described below by referring to the drawings.

### First Embodiment

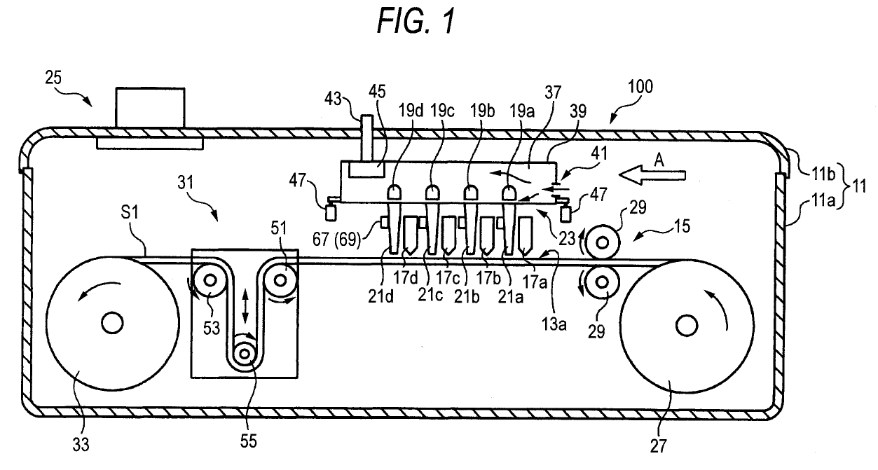

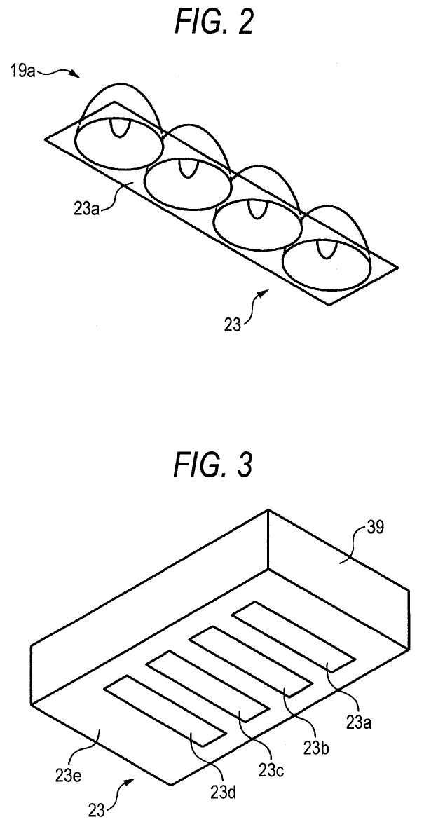

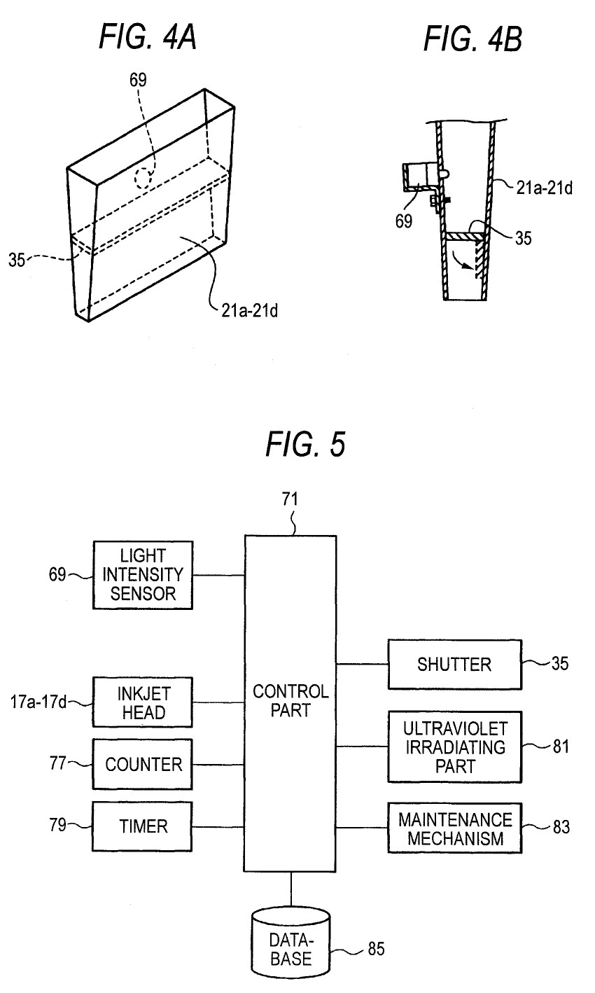

FIG. 1 is a schematic construction view of the active energy curing-type inkjet recording apparatus according to the first embodiment of the present invention; FIG. 2 is an enlarged perspective view of the ultrahigh-pressure mercury lamp equipped in the active energy curing-type inkjet recording apparatus shown in FIG. 1; FIG. 3 is a perspective view of segment separating means equipped in the active energy curing-type inkjet recording apparatus shown in FIG. 1; and FIGS. 4A and 4B are a perspective view and a side view B, respectively, of the light guiding part equipped in the active energy curing-type inkjet recording apparatus shown in FIG. 1.

The active energy curing-type inkjet recording apparatus (inkjet recording apparatus) 100 comprises a cases 11 having provided therein a scan-conveying part 15 in which the recording medium S1 is conveyed to the arrow A direction in the Figure under a held state in the image recording range 13a, four inkjet heads 17a to 17d which eject an ink capable of being cure with an active energy (active energy-curable ink) on the recording medium S1 in the image recording range 13a, four-row ultrahigh-pressure mercury lamps 19a to 19d which are an active energy source disposed at least downstream of respective inkjet heads 17a to 17d in the recording medium S1 conveying direction, light guiding parts 21a to 21d which are each disposed between the ultrahigh-pressure mercury lamp 19a to 19d and the active energy irradiating position on the recording medium S1 at the position downstream of each inkjet head 17a to 17d in the conveying direction and which guide the irradiation light emitted from the ultrahigh-pressure mercury lamps 19a to 19d to the recording medium S1, and segment separating means 23 which separates the ultrahigh-pressure mercury lamps 19a to 19d from the scan-conveying part 15, the inkjet heads 17a to 17d and the light guiding pats 21a to 21d by a transparent member covering at least the irradiating faces of the ultrahigh-pressure mercury lamps 19a to 19d. In addition, the ultrahigh-pressure mercury lamps 19a to 19d, light guiding parts 21a to 21d and segment separating means 23 constitute an irradiating unit.

In this inkjet recording apparatus 100, the active energy-curable ink ejected on the recording medium S1 by the inkjet heads 17a to 17d is cured by irradiating an active energy from the ultrahigh-pressure mercury lamps 19a to 19d, whereby image recording on the recording medium S1 is performed.

The casing 11 has a construction comprising a nearly box-shaped case body 11a with the top face open and a maintenance-use open/close cover 11b open/closeably covering the open part of the top face of the case body 11a. On the open/close cover 11b, ventilation means 25 for ventilating the atmosphere inside the casing 11 is equipped. The ventilation means 25 has deodorizing means for removing the ink odor in the exhaust air.

The recording medium S1 used in this embodiment is a lengthy roll paper sheet.

In the scan-conveying part 15, the recording medium S1 wound around a delivery-side roll 27 is conveyed to the image recording range 13a by the recording medium conveying means (conveying roller) 29, and the recording medium S1 after image recording in the image recording range 13a is fed to the takeup-side roll 33 through a tension adjusting mechanism 31 and taken up on the takeup-side roll 33.

The inkjet heads 17a to 17d all are a full-line type inkjet head having ejection nozzles over the entire region in the width direction (in FIG. 1, the direction crossing at right angles with the paper sheet having the drawing) of the recording medium S1. These inkjet heads 17a to 17d are equipped to eject inks differing in the color for effecting full-color printing by four color inks.

The inkjet heads 17a to 17d are equipped with a fixed spacing from each other in the recording medium S1 conveying direction. A head driver (control circuit) not shown is connected to each of the inkjet heads 17a to 17d, and the ejection timing and ejection amount of the ink in the assigned color are controlled by a signal from the head driver.

The ultrahigh-pressure mercury lamps 19a to 19d correspond to respective inkjet heads 17a to 17d disposed with a spacing in the recording medium S1 conveying direction and are disposed every each inkjet head 17a to 17d to locate above the inkjet heads 17a to 17d and downstream in the recording medium S1 conveying direction.

The ultrahigh-pressure mercury lamps 19a to 19d each is a point light source of emitting, for example, ultraviolet light at a wavelength of 250 to 600 nm. As shown in FIG. 2, the mercury lamp is equipped every each head as a row of a plurality of light sources arrayed straightway along the width direction of the recording medium S1 and creates a belt-like irradiation zone extending over the entire region in the width direction of the recording medium S1.

The periphery of the light guiding parts 21a to 21d is light-shielded not to allow for irradiation of light on the head and the like and as shown in FIG. 1, the light guiding part is disposed on the downstream side in the recording medium S1 conveying direction with respect to each inkjet head 17a to 17d such that one end works out to the face opposing the corresponding ultrahigh-mercury lamp 19a to 19d and the other end works out to the face opposing the recording medium S1, and causes the irradiation light of the ultrahigh-pressure mercury lamp 19a to 19d incident on one end to be emitted from the other end and irradiated on the recording medium S1.

The light guiding parts 21a to 21d each is formed nearly in the wedge shape with one end side being smaller than the other end side so as not to induce stray light resulting from diffusion of irradiation light emitted. The light guiding parts 21a to 21d each may be constructed as a hollow box body or in an opaque cylinder form by opening one end to the corresponding ultrahigh-pressure mercury lamp 19a to 19d and opening the other end to the recording medium S1.

The segment separating means 23 is a plate-like body inserted between one-end faces of the light guiding parts 21a to 21d and irradiation faces of the ultrahigh-pressure mercury lamps 19a to 19d. As shown in FIG. 3, the portion covering the irradiation face of each of the ultrahigh-pressure mercury lamps 19a to 19d is formed of a belt-like transparent member 23a to 23d, and the periphery of each of the transparent members 23a to 23d is formed of an opaque member 23e which blocks out the light irradiated from the ultrahigh-pressure mercury lamps 19a to 19d. In the segment separating means 23, the transparent members 23a to 23d and opaque member 23e each is set to a size so that the opaque member 23e can block out the light other than in the light guiding range of the light guiding parts 21a to 21d.

In this embodiment, the component composition and the like of each of the transparent members 23a to 23d in the segment separating means 23 are set so as to enable blocking a heat ray contained in the irradiation light of the ultrahigh-pressure mercury lamps 19a to 19d.

Furthermore, in this embodiment, as shown in FIG. 4, the light guiding parts 21a to 21d each has a mechanical light-shielding shutter 35 in the inside thereof. The light-shielding shutter 35 is operated by control means (not shown) to a light-shielded state of blocking off the light guiding path or an opened state of canceling the light shielding. Also, a light intensity sensor 69 assuming the active energy intensity detection part is fixed to the outside surface of each of the light guiding parts 21a to 21d.

In the light intensity sensor 69, the detection part is exposed to the inside of the light guiding parts 21a to 21d through a hole provided on the side surface of each of the light guiding parts 21a to 21d and after detecting the illuminance of the active energy, the sensor output is sent to the control part 71 described later.

In this embodiment, as shown in FIG. 1, a gap for passing a cooling air is ensured between the segment separating means 23 and the irradiation face of each of the ultrahigh-pressure mercury lamps 19a to 19d so as to prevent the heat generation of the ultrahigh-pressure mercury lamps 19a to 19d from being transmitted to the light guiding parts 21a to 21d or the inkjet heads 17a to 17d through the segment separating means 23.

The segment separating means 23 has a cover 39 which defines a space 37 for housing respective ultrahigh-pressure mercury lamps 19a to 19d, in cooperation with the segment separating means 23. In the cover 39, an air inlet port 41 for introducing the outside air into the space 37 and an air outlet port 43 for releasing the heated atmosphere in the space 37 to the outside are provided, and the air outlet port 43 is equipped with a cooling fan 45 for forcedly ventilating the atmosphere in the space 37.

In this embodiment, as shown in FIG. 1, the cover 39 further has vibration-proofing means 47 for suppressing the vibration which is transmitted from the outside of the casing 11 to the ultrahigh-pressure mercury lamps 19a to 19d. As for the vibration-proofing means 47, in addition to a sliding-type shock absorber of attenuating the vibration or shock, various seismic isolation structures, antiseismic materials and vibration-absorbing materials can be used. This means may also be disposed directly on the ultrahigh-pressure mercury lamps 19a to 19d.

Conveying rollers 29 which are recording medium conveying means are provided on the upstream side in the recording medium conveying direction of the image recording range 13a, and the conveying rollers 29 convey the recording medium S1 to the takeup-side roll 33 after passing through the image recording range 13a. A tension adjusting mechanism 31 is provided between the image recording range 13a and the takeup-side roll 33. The tension adjusting mechanism 31 comprises a pair of feed rollers 51 and 53 which are spaced apart a predetermined distance and come into contact with the back surface of the recording medium S1, and a step roller 55 which is provided between these feed rollers 51 and 53 and comes into contact with the front surface of the recording medium S1.

The step roller 55 which is a constituent member of the tension adjusting mechanism 31 moves in the vertical and tilt directions to adjust the tension of the recording medium S1 for conveying the recording medium S1 with suppressed action of generating an excessive tension or a biased tension in the width direction of the recording medium and thereby preventing reduction in the quality of the recording medium S1.

The control system of the inkjet recording apparatus 100 is described below. FIG. 5 is a block diagram of the control means.

In the inkjet recording apparatus 100, a control part 71 as control means is provided. As regards the control part 71, for example, a computer with CPU may be used. To the control part 71, an operation panel and the like (not shown) provided in the inkjet recording apparatus 100 are connected. Also, a light intensity sensor 69, inkjet heads 17a to 17d, a counter 77, a timer 79, a shutter 35, an ultraviolet irradiating part 81, a maintenance mechanism 83, a data base 85 and the like are connected to the control part 71. The operations of these constituent elements are controlled by inputting a detection signal into the control part 71 or by an operational control signal delivered from the control part 71.

The control part 71 delivers a control signal based on a count signal input from the counter 77. Here, the counter 77 may be recording-processed length counting means of counting the recording-processed length of the recording medium S1 by the pulse measurement or the like. In this case, the recording-processed amount of the recording medium S1 consumed along with image recording is counted by the counter 77, and the count signal is delivered to the control part 71. The light intensity sensor 69 and the maintenance mechanism 83 each operates every time when the recording medium S1 in a predetermined amount is recording-processed, and performs the maintenance of active energy intensity detection. According to this construction, the maintenance requirement increasing in accordance with the recording-processed amount of the recording medium S1 can be responded.

Also, the counter 77 may be nozzle operation time counting means of counting the nozzle operation time of the inkjet heads 17a to 17d. In this case, the nozzle operation time increasing along with image recording is counted by the counter 77, and the count signal is delivered to the control part 71. The light intensity sensor 69 and the maintenance mechanism 83 each performs the maintenance of active energy intensity detection every predetermined nozzle operation time. According to this construction, the maintenance requirement increasing in accordance with the nozzle operation time can be responded.

The timer 79 may be an irradiation time counting timer of counting the operation time of the ultrahigh-pressure mercury lamps 19a to 19d. In this case, the irradiation time of the ultrahigh-pressure mercury lamps 19a to 19d is counted by the timer 79, and the count signal is delivered to the control part 71. The light intensity sensor 69, the ultraviolet irradiating part 81 and the maintenance mechanism 83 each performs the maintenance of active energy intensity detection every predetermined irradiation time. According to this construction, the maintenance requirement increasing in accordance with the irradiation time of the ultrahigh-pressure mercury lamps 19a to 19d can be responded.

Also, the control pert 71 may cause the light intensity sensor 69, the ultraviolet irradiating part 81 and the maintenance mechanism 83 to operate at arbitrary timing to perform the maintenance of active energy intensity detection In this case, the control part 71 delivers a control signal based on a manual signal created, for example, by pressing a maintenance switch provided on an operation panel or the like (not shown), whereby the maintenance of active energy intensity detection can be performed similarly to the above.

The operation of the inkjet recording apparatus 100 is described below.

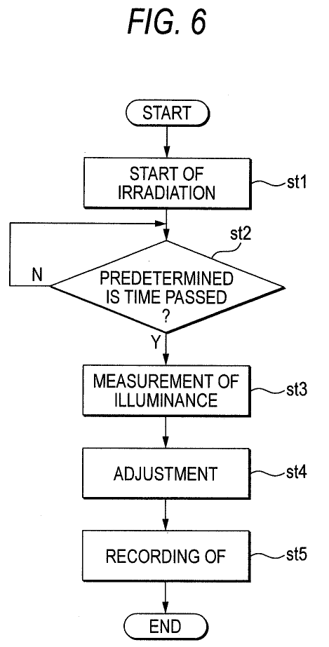

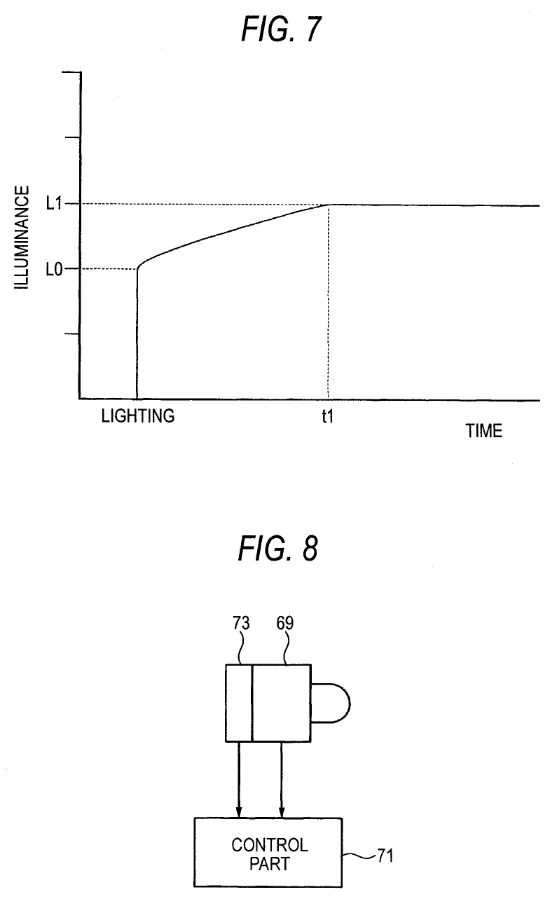

FIG. 6 is a flow chart showing one example of the procedure in the drive control method, and FIG. 7 is a graph showing the correlation between the lighting elapsed time and the illuminance of the light intensity sensor.

In the inkjet recording apparatus 1001 when the operation is started based on the command from the control part 71 and the ultrahigh-pressure mercury lamps 19a to 19d are lighted (st1), the lighting time of the ultrahigh-pressure mercury lamps 19a to 19d is counted by the timer 79 and passing of a predetermined time is waited (st2). Here, the predetermined time indicates a time period passed to the extent of allowing the temperature of the ultrahigh-pressure mercury lamps 19a to 19d to be stabilized, and this time period can be previously known by a preliminary test or the like and stored in the data base 85. The time period passed to the extent of allowing the temperature of the ultrahigh-pressure mercury lamps 19a to 19d to be stabilized is also a time period where the temperature of the light intensity sensor 69 heated by the heat generation from the ultrahigh-pressure mercury lamps 19a to 19d is stabilized. After the passing of a predetermined time, the light intensity sensor 69 detects the illuminance on the ejection faces of the light guiding parts 21a to 21d (st3).

As shown in FIG. 7, the illuminance elevates from L0 to L1 with the passing of lighting time of the ultrahigh-pressure mercury lamps 19a to 19d and after passing of a time period t1, the illuminance reaches a fixed illuminance L1 and is thereafter stabilized. This agrees with the elevation of temperature of the ultrahigh-pressure mercury lamps 19a to 19d due to lighting and after the passing of time to the extent of allowing the temperature of the ultrahigh-pressure mercury lamps 19a to 19d to be stabilized, that is, in FIG. 7, after passing of a time period t1, the temperatures of the ultrahigh-pressure mercury lamps 19a to 19d and the light intensity sensor 69 are stabilized, so that when the illuminance is measured here, fluctuation in the sensor output of the light intensity sensor 69 having temperature characteristics can be suppressed and the light intensity can be measured with high precision. In addition, a change of temperature is preferably 5° C. per minute or less, more preferably 3° C. per minute or less.

Subsequently, the control part 71 which is also the irradiation condition control means adjusts the irradiation conditions of the active energy on the recording medium S1 based on the measured energy intensity value (st4), and the adjustment contents are entered into the data base 85 (st5).

In place of waiting for the lighting time of the ultrahigh-pressure mercury lamps 19a to 19d to pass a predetermined time, as shown in FIG. 8, a temperature sensor 73 such as thermocouple may be fixed to the light intensity sensor 69 to detect the temperature of the light intensity sensor 69 and measure the illuminance after confirming that the temperature has entered an equilibrium state.

The adjustment of irradiation conditions of the active energy on the recording medium S1 is, for example, an illuminance correcting treatment performed based on the measured irradiation active energy intensity value. In the illuminance correcting treatment, when the measured irradiation active energy intensity value is delivered to the control part (irradiation condition control means) 71, a correction value corresponding thereto is read out from the data table stored in the data base 85. Based on this correction value, the control part 71 performs an illuminance compensating treatment of changing the irradiation conditions of the active energy on the recording medium S1.

The control part 71 performs control to increase the drive voltage of the ultrahigh-pressure mercury lamps 19a to 19d when the measured irradiation active energy intensity value is less than the specified illuminance, and performs control to reduce the drive voltage when the measured value exceeds the specified illuminance, whereby the integral irradiation amount on the recording medium S1 is increased or decreased and curing equal to that attained by the irradiation with the specified illuminance can be effected. As for other illuminance correcting treatments, a treatment of controlling the recording medium conveying speed may also be employed. Also by this treatment, the integral irradiation amount on the recording medium S1 is increased or decreased and curing equal to that attained by the irradiation with the specified illuminance can be effected.

According to the inkjet recording apparatus 100 of this embodiment, the energy intensity is measured by the energy intensity measuring means 69 after the passing of time to the extent of allowing the temperature of ultrahigh-pressure mercury lamps 19a to 19d to be stabilized at the start-up from lighting or rest of the ultrahigh-pressure mercury lamps 19a to 19d, so that fluctuation of the measurement result based on the temperature characteristics of the energy intensity measuring means 69 can be suppressed and the energy intensity can be stably measured.

Also, the irradiation conditions of the active energy on the recording medium S1 is controlled by the irradiation condition control means 71 based on the energy intensity value measured by the energy intensity measuring means 69 after the passing of time to the extent of the temperature of the ultrahigh-pressure mercury lamps 19a to 19d to be stabilized, so that an active energy with a predetermined energy intensity can be stably irradiated on the active energy-curable ink and a high-quality image can be formed.

Furthermore, the active energy is an ultraviolet ray and the energy intensity measuring means is light intensity measuring means 69, so that the apparatus can be advantageous in terms of easy handling of the light source and compactness and the light intensity can be easily measured. Furthermore, a UV-curable ink can be used and this enables high-speed fixing, as a result, high-speed conveyance of a recording medium, that is, high-speed recording can be realized. In addition, the ultrahigh-pressure mercury lamps 19a to 19d, so that an inexpensive, compact and easily handleable light source can be obtained.

### Second Embodiment

The active energy curing-type inkjet recording apparatus of the second embodiment is described below.

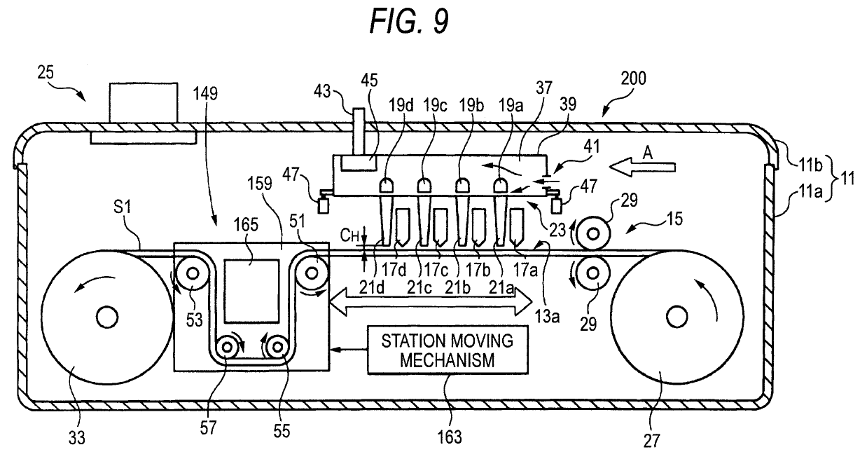

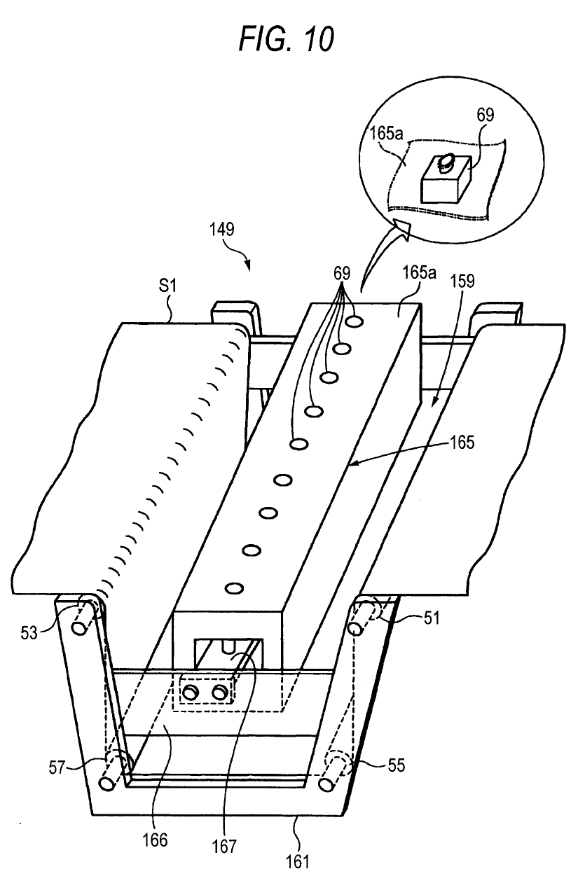

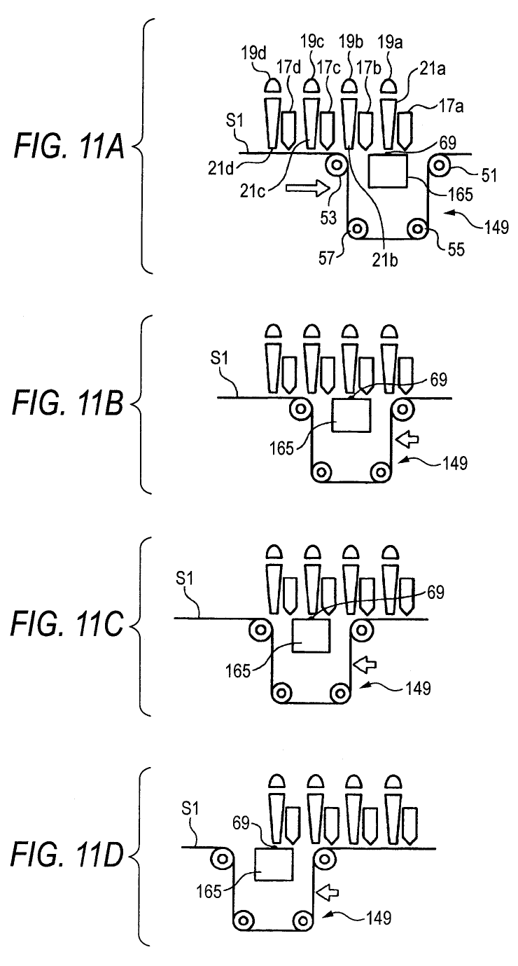

FIG. 9 is a schematic construction view of the active energy curing-type inkjet recording apparatus according to the second embodiment; FIG. 10 is an enlarged perspective view of the conveyance path changing means and the sensor station shown in FIG. 9; and FIGS. 11A to 11D are operation explanatory views where one example of the active energy detecting step for the irradiating unit is shown.

The active energy curing-type inkjet recording apparatus 200 of the second embodiment comprises conveyance path changing means 149 and at the same time, comprises energy intensity measuring means 69 in a sensor station 165. The members other than these have many in common with the active energy curing-type inkjet recording apparatus 100 of the first embodiment and therefore, the same members as the members shown in FIGS. 1 to 7 are indicated using the same reference characters by omitting repeated description thereof here.

The recording medium S1 used in this embodiment is a lengthy roll paper sheet.

In the scan-conveying part 15, the recording medium S1 wound around a delivery-side roll 27 is conveyed to the image recording range 13a by the recording medium conveying means (conveying roller) 29, and the recording medium S1 after image recording in the image recording range 13a is fed to the takeup-side roll 33 by conveyance path changing means 149 described later and taken up on the takeup-side roll 33.

Conveying path changing means 149 provided between the image recording range 13a and the takeup-side roll 33 comprises a pair of feed rollers 51 and 53 which are spaced apart a predetermined distance and come into contact with the back surface of the recording medium S1, and step rollers 55 and 57 which are provided between these feed rollers 51 and 53 and come into contact with the front surface of the recording medium S1.

The conveyance path changing means 149 stretches the recording medium S1 over the feed rollers 51 and 53 and the step rollers 55 and 57 and thereby diverts the recording medium S1 midway of the recording medium S1 conveying path to form a housing space 159 surrounded by the recording medium S1 below the conveyance path faces of the light guiding parts 21a to 21d.

In the conveyance path changing means 149, as shown in FIG. 10, both axis ends of each of the feed rollers 51 and 53 and the step rollers 55 and 57 are supported in a bracket 161. A station moving mechanism 163 is provided between the delivery-side roll 27 and the takeup-side roll 33 in the bottom of the casing 11, and the station moving mechanism 163 is supporting the bracket 161 of the conveyance path changing means 149 along a guide rail (not shown) to be reciprocatable in the recording medium conveying direction below the image recording range 13a.

The step rollers 55 and 57 as constituent members of the conveyance path changing means 149 are provided to be accessible and retractable with respect to the feed rollers 51 and 53 or to be accessible, retractable and tiltable between the step rollers 55 and 57, whereby the stretching and meandering of the recording medium S1 can be adjusted. Accordingly, also when the conveyance path changing means 149 is moved while forming a housing space 159 midway of the recording medium S1, by virtue of operation of the step rollers 55 and 57 provided in the conveyance path changing means 149 operate, the action of generating an excessive tension or a biased tension in the recording medium S1 relatively moved by the movement of the conveyance path changing means 149 is suppressed and the recording medium S1 is prevented from reduction in the quality.

A sensor station 165 is provided in the housing space 159 of the conveyance path changing means 149. The sensor station 165 is supported by fixing a stay 167 connected with the sensor station 165 body to a supporting plate 166 erected on both end parts of the bracket 161. The sensor station 165 is moved along with movement of the conveyance path changing means 149, whereby the top face 165a of the sensor station 165 can be in the face-to-face alignment with the light ejection faces of the light guiding parts 21a to 21d.

On the top face 165a of the sensor station 165, a plurality of light intensity sensors 69 which are an active energy intensity detection part are juxtaposed, for example, in the width direction of the recording medium. The light intensity sensor 69 detects the illuminance of the active energy and delivers the sensor output to the control part.

The conveyance path changing means 149 makes the sensor station 165 to be movable to the position opposing the light guiding parts 21a to 21d by relatively moving the recording medium S1. In this embodiment, a plurality of ultrahigh-pressure mercury lamps 19a to 19d are juxtaposed, and the sensor station 165 is sequentially moved along the recording medium S1 conveyance path to respective face-to-face positions of the ultrahigh-pressure mercury lamps 19a to 19d. Accordingly, even in a construction where a plurality of ultrahigh-pressure mercury lamps 19a to 19d are juxtaposed along the recording medium S1 conveying direction, the sensor station 165 can be made in face-to-face alignment with each of a plurality of ultrahigh-pressure mercury lamps 19a to 19d by causing the conveyance path changing means 149 to sequentially move along the recording medium S1 conveying direction, so that the sensor station 165 can be constructed in a compact size corresponding to individual ultrahigh-pressure mercury lamps 19a to 19d.

The operation of the inkjet recording apparatus 200 is described below.

In the inkjet recording apparatus 200, when an active energy intensity detection signal is delivered from the control part 71, the station moving mechanism 163 and the conveyance path changing means 149 are driven and, as shown in FIG. 11A, the conveyance path changing means 149 and the sensor station 165 are moved to the upstream side in the recording medium conveying direction.

Subsequently, the conveyance path changing means 149 is moved to the downstream side in the recording medium conveying direction by the station moving mechanism 163 and along with this, as shown in FIGS. 11A to 11D, the light intensity sensors 69 of the sensor station 165 sequentially coming to face the light guiding parts 21a to 21d detect the illuminance on the ejection faces of the light guiding parts 21a to 21d in sequence.

The illuminance detection by the light intensity sensor 69 is performed after the passing of time to the extent of allowing the temperature of the ultrahigh-pressure mercury lamps 19a to 19d or light intensity sensor 69 to be stabilized, whereby the illuminance every light intensity sensors 69 along the head longitudinal direction is measured at respective detection positions in the recording medium conveying direction. The control part 71 which is also the irradiation condition control means adjusts the irradiation conditions of the active energy on the recording medium S1 based on the measured energy intensity value, and this is the same as in the first embodiment.

In this way, in the inkjet recording apparatus 200 of the second embodiment, the recording medium S1 is diverted from the position right below the irradiating unit by the conveyance path changing means 149 midway of the recording medium S1 conveyance path, and a housing space 159 surrounded by the recording medium S1 is formed right below the irradiating unit. The sensor station 165 having provided thereon light intensity sensors 69 is disposed in this housing space 159, so that even in an image recording apparatus using a web-like recording medium S1, the light intensity can be more stably measured by the light intensity sensor 69 by arranging the sensor station 165 to oppose the irradiating unit.

Also, in the active energy curing-type inkjet recording apparatus 200, the active energy is an ultraviolet ray and therefore, this apparatus is advantageous in terms of easy handling of the light source and compactness. At the same time, a UV-curable ink can be used and this enables high-speed fixing, as a result, high-speed conveyance of a recording medium S1, that is, high-speed recording can be realized.

Furthermore, the active energy-curable ink coated on the recording medium S1 can be swiftly cured by the irradiation of an active energy from ultrahigh-pressure mercury lamps 19a to 19d, so that a high-quality image can be recorded on various recording mediums S1 by utilizing the properties of the active energy-curable ink.

Moreover, low-cost ultrahigh-pressure mercury lamps 19a to 19d are introduced as the light source for the active energy irradiation, so that the apparatus cost can be reduced as compared with the conventional active energy curing-type inkjet recording apparatus employing a high-cost light source.

### Third Embodiment

The inkjet recording apparatus of the third embodiment where the sensor station is modified is described below. The portions in common with the inkjet recording apparatuses 100 and 200 of the first and second embodiments are indicated by the same or corresponding reference characters, and repeated description thereof is omitted.

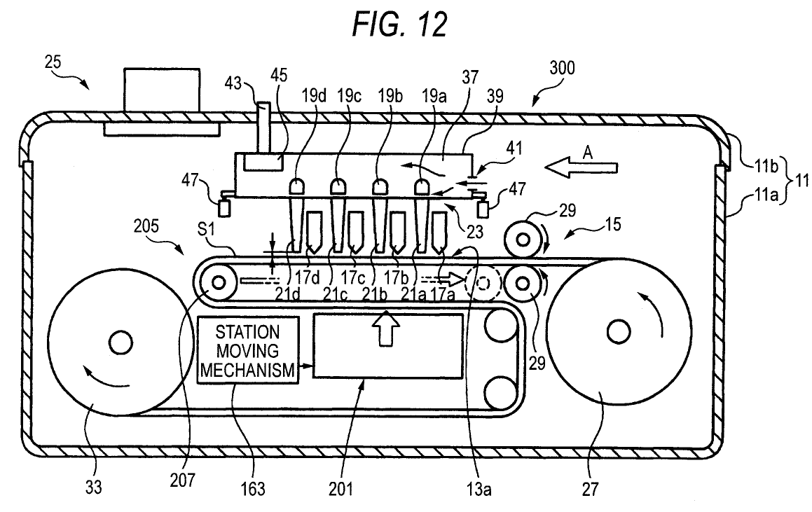

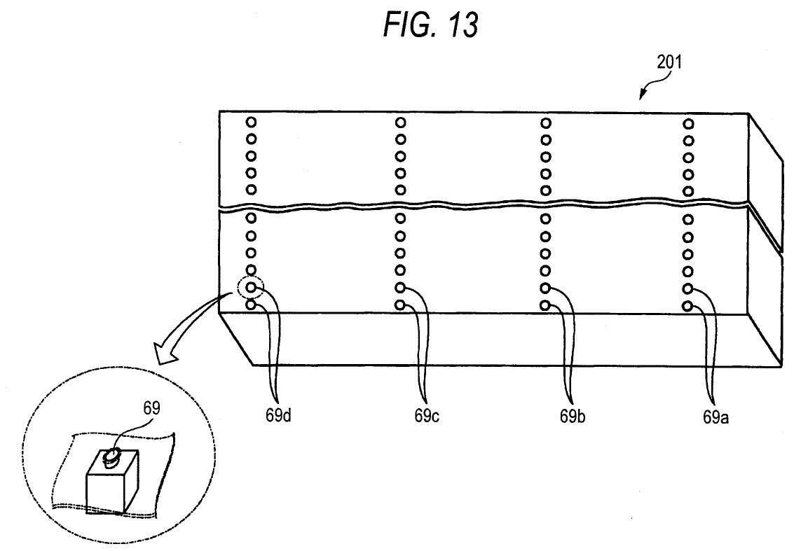

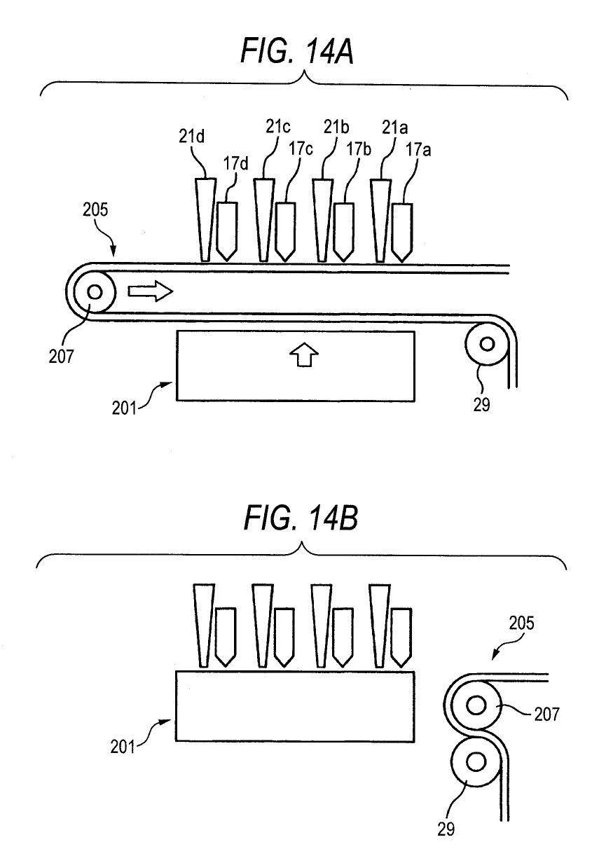

FIG. 12 is a schematic construction view of the active energy curing-type inkjet recording apparatus in the embodiment of face-to-face position; FIG. 13 is a perspective view when the sensor station shown in FIG. 12 is viewed from above; and FIG. 14 is an operation explanatory view of the active energy curing-type inkjet recording apparatus shown in FIG. 12.

In the inkjet recording apparatus 300 according to this embodiment, a plurality of ultrahigh-pressure mercury lamps 19a to 19d with light guiding parts 21a to 21d, which are an irradiating unit, are juxtaposed. The sensor station 201 is vertically movably supported and at the same time, as shown in FIG. 13, equipped with light intensity sensors 69 (69a, 69b, 69c, 69d) in a plurality of rows aligned to correspond to respective irradiating unit.

Also, in this inkjet recording apparatus 300, the conveyance path changing means 205 comprises a movable roller 207 which is horizontally movable. In the conveyance path changing means 205, as shown in FIGS. 14A and 14B, the movable roller 207 is moved along the recording medium conveying direction to the accessible or retractable direction with respect to the conveying roller 29, whereby the sensor station 201 can be made in face-to-face alignment with the plurality of irradiating unit at the same time.

Therefore, according to the inkjet recording apparatus 300 of this embodiment, the plurality of irradiating units can be detected all at once by the sensor station 201 having a plurality of light intensity sensors 69a, 69h, 69c and 69d corresponding to respective irradiating units, and the detection of the plurality of irradiating units can be performed in a short time.

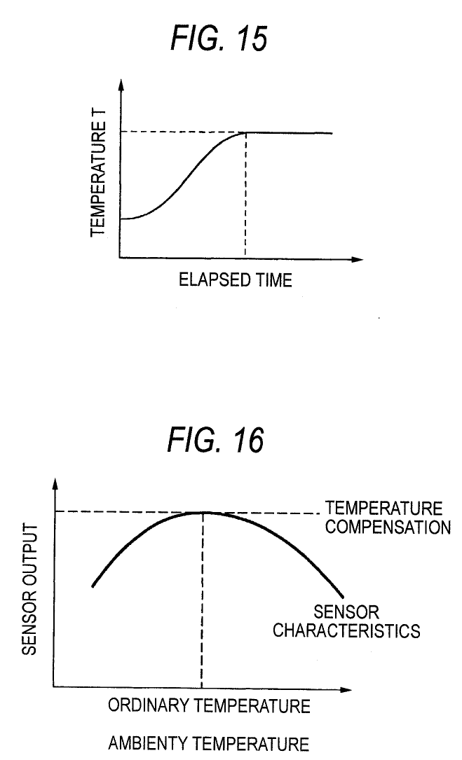

Incidentally, the measurement of illuminance by each of the light intensity sensors 69a, 69b, 69c and 69d is, as shown in FIG. 15, of course performed after a predetermined time is passed from lighting of the ultrahigh-pressure mercury lamps 19a to 19d to allow stabilization of the temperature of the ultrahigh-pressure mercury lamps 19a to 19d or light intensity sensors 69. At this point, the temperature of the light intensity sensors 69a, 69b, 69c and 69d is also stabilized to create a constant temperature condition, so that the temperature characteristics of the light intensity sensors 69a, 69b, 69c and 69d shown in FIG. 16 can be suppressed and the illuminance can be measured with high precision.

The “active energy ray (also simply referred to as active energy ray)” as used in the present invention is not particularly limited as long as its irradiation can impart energy capable of generating an initiation species in the ink composition, and widely includes α-ray, γ-ray, X-ray, ultraviolet ray, visible ray, electron beam and the like. Among these, in view of curing sensitivity and easy availability of the apparatus, ultraviolet ray and electron beam are preferred, and ultraviolet ray is more preferred. Accordingly, the ink composition for use in the present invention is preferably an ink composition which can be cured by the irradiation of ultraviolet ray.

In the inkjet recording apparatus of the present invention, the peak wavelength of active energy varies depending on the absorption characteristics of the sensitizing dye in the ink composition but is suitably, for example, from 200 to 600 nm, preferably from 300 to 450 nm, more preferably from 350 to 450 nm. Also, the (a) electron transfer-type initiation system of the ink composition for use in the present invention exhibits sufficiently high sensitivity even for low-output active energy. Accordingly, the output of the active energy used as the irradiation energy is suitably, for example, 2,000 mJ/cm² or less, preferably from 10 to 2,000 mJ/cm², more preferably from 20 to 1,000 mJ/cm², still more preferably from 50 to 800 mJ/cm². Also, the active energy is suitably irradiated at an exposure surface illuminance (a maximum illuminance on the recording medium surface) of, for example, from 10 to 2,000 mW/cm², preferably from 20 to 1,000 mW/cm².

Particularly, in the inkjet recording apparatus of the present invention, the active energy is preferably irradiated from a light-emitting diode which can generate an ultraviolet ray having an emission wavelength peak of 390 to 420 nm and giving a maximum illuminance of 10 to 1,000 mW/cm² on the recording medium surface.

Also, in the inkjet recording apparatus of the present invention, the active energy suitably irradiates the ink composition ejected on a recording medium, for example, for 0.01 to 120 seconds, preferably from 0.1 to 90 seconds.

Furthermore, in the inkjet recording apparatus of the present invention, it is preferred that the ink composition is heated to a fixed temperature and the time from the landing of ink composition on a recording medium to the irradiation of active energy is set to 0.01 to 0.5 seconds, preferably from 0.02 to 0.3 seconds, more preferably from 0.03 to 0.15 seconds. By virtue of controlling the time from the landing of ink composition on a recording medium to the irradiation of active energy to such a very short time, the ink composition landed can be prevented from bleeding before curing.

For obtaining a color image by using the inkjet recording apparatus of the present invention, the colors are preferably superposed in the color value order from lower to higher. When superposed in such an order, the active energy can readily reach the ink in the lower part and this can be expected to yield good curing sensitivity, reduction of residual monomer, decrease of odor and enhancement of adhesive property. As for the irradiation of active energy, all colors may be ejected and en bloc exposed, but exposure is preferably performed every each color in view of accelerating the curing.

As described above, in the case of active energy-curable ink like the ink composition of the present invention, the ink composition ejected is preferably kept at a constant temperature and therefore, the temperature in the region from the ink supply tank to the inkjet head portion is preferably controlled by heat insulation and heating. Also, the head unit is preferably heated by thermally shielding or insulating the apparatus body so as not to receive an effect from the temperature of outer air. In order to shorten the printer start-up time necessary for heating or reduce the loss of heat energy, in combination with thermal insulation from other sites, the heat capacity of the entire heating unit is preferably made small.

As for the active energy source, a mercury lamp, a gas/solid laser and the like are principally utilized and for the ultraviolet curing-type inkjet, a mercury lamp and a metal halide lamp are widely known. Furthermore, replacement by a GaN-based semiconductor ultraviolet light-emitting device is industrially and environmentally very useful. In addition, LED (UV-LED) and LD (UV-LD) are compact, long-lived, highly efficient and low costing and are promising as a radiation source for active energy curing-type inkjet.

As described above, a light-emitting diode (LED) and a laser diode (LD) can be used as the active energy source. In particular, when an ultraviolet source is necessary, an ultraviolet LED or an ultraviolet LD can be used. For example, an ultraviolet LED of which main emission spectrum has a wavelength between 365 nm and 420 nm is commercially available from Nichia Corp. Also, when a further shorter wavelength is required, an LED capable of emitting active energy having a primary emission between 300 nm and 370 nm is disclosed in U.S. Pat. No. 6,084,250. Other ultraviolet LEDs are also available, and radiations in different ultraviolet bands may be irradiated. The active energy source for use in the present invention is preferably UV-LED, more preferably UV-LED having a peak wavelength in the region of 350 to 420 nm.

### (Recording Medium)

The recording medium to which the ink composition of the present invention can be applied is not particularly limited and normal paper sheets such as non-coated paper and coated paper, and various non-absorptive resin materials and resin films shaped therefrom, which are used in so-called soft packaging, may be used. Examples of various plastic films include PET film, OPS film, OPP film, ONy film, PVC film, PE film and TAC film. Other examples of the plastic usable as the recording medium material include polycarbonate, acrylic resin, ABS, polyacetal, PVA and rubbers. Furthermore, metals and glasses may also be used as the recording medium.

In the ink composition of the present invention, when a material less causing heat shrinkage at curing is selected, excellent adhesive property is obtained between the cured ink composition and the recording medium and this is advantageous in that a high-definition image can be formed even on a film susceptible to curling or deformation due to, for example, curing shrinkage of ink or heat generation at the curing reaction, such as PET film, OPS film, OPP film, ONy film and PVC film which are thermally shrinkable.

The constituent components for use in the ink composition usable in the present invention are described below in sequence.

### (Ink Composition)

The ink composition for use in the present invention is an ink composition capable of being cured by the irradiation of active energy, and examples thereof include a cationic polymerization-type ink composition, a radical polymerization-type ink composition and an aqueous ink composition. These compositions are described in detail below.

### (Cationic Polymerization-Type Ink Composition)

The cationic polymerization-type ink composition contains (a) a cationic polymerizable compound and (b) a compound capable of generating an acid upon irradiation with active energy and if desired, may further contain a colorant, an ultraviolet absorbent, a sensitizer, an antioxidant, a discoloration inhibitor, electrically conducting salts, a solvent, a polymer compound, a surfactant and the like.

The constituent components used in the cationic polymerization-type ink composition are described below in sequence.

(a) (Cationic Polymerizable Compound)

The (a) cationic polymerizable compound for use in the present invention is not particularly limited as long as it is a compound capable of being cured by causing a polymerization reaction using an acid generated from the (b) compound capable of generating an acid upon irradiation with active energy, and various known cationic polymerizable monomers known as a photo-cationic polymerizable monomer may be used. Examples of the cationic polymerizable monomer include epoxy compounds, vinyl ether compounds and oxetane compounds described in JP-A-6-9714, JP-A-2001-31892, JP-A-2001-40068, JP-A-2001-55507, JP-A-2001-310938, JP-A-2001-310937 and JP-A-2001-220526.

Examples of the epoxy compound include an aromatic epoxide, an alicyclic epoxide and an aliphatic epoxide.

The aromatic epoxide includes a di- or polyglycidyl ether produced by the reaction of a polyhydric phenol having at least one aromatic nucleus or an alkylene oxide adduct thereof with epichlorohydrin. Examples thereof include a di- or polyglycidyl ether of bisphenol A or an alkylene oxide adduct thereof, a di- or polyglycidyl ether of hydrogenated bisphenol A or an alkylene oxide adduct thereof, and a novolak-type epoxy resin. Examples of the alkylene oxide include an ethylene oxide and a propylene oxide.

As for the alicyclic epoxide, a cyclohexene oxide- or cyclopentene oxide-containing compound obtained by epoxidizing a compound having at least one cycloalkene ring such as cyclohexene or cyclopentene ring with an appropriate oxidizing agent such as hydrogen peroxide and peracid is preferred.

Examples of the aliphatic epoxide include a di- or polyglycidyl ether of an aliphatic polyhydric alcohol or an alkylene oxide adduct thereof. Representative examples thereof include a diglycidyl ether of an alkylene glycol, such as diglycidyl ether of ethylene glycol, diglycidyl ether of propylene glycol, and diglycidyl ether of 1,6-hexanediol; a polyglycidyl ether of a polyhydric alcohol, such as di- or triglycidyl ether of glycerin or an alkylene oxide adduct thereof; and a diglycidyl ether of a polyalkylene glycol, as represented by a diglycidyl ether of a polyethylene glycol or an alkylene oxide adduct thereof, and a diglycidyl ether of a polypropylene glycol or an alkylene oxide adduct thereof. Here, examples of the alkylene oxide include an ethylene oxide and a propylene oxide.

The epoxy compound may be monofunctional or polyfunctional.

Examples of the monofunctional epoxy compound which can be used in the present invention include phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monoxide, 1,2-epoxydodecane, epichlorohydrin, 1,2-epoxydecane, styrene oxide, cyclohexene oxide, 3-methacryloyloxymethylcyclohexene oxide, 3-acryloyloxymethylcyclohexene oxide and 3-vinylcyclohexene oxide.

Examples of the polyfunctional epoxy compound include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolak resin, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexane carboxylate, 2-(3,4-epoxycyclohexyl-5,5-spiro-3,4-epoxy)cyclohexane-meta-dioxane, bis(3,4-epoxycyclohexylmethyl)adipate, vinylcyclohexene oxide, 4-vinylepcxycyclohexane, bis(3,4-epoxy-6-methylcyclohexylmethyl)adipate, 3,4-epoxy-6-methylcyclohexyl-3′,4′-epoxy-6′-methylcyclohexane carboxylate, methylenebis(3,4-epoxycyclohexane), dicyclopentadiene diepoxide, di(3,4-epoxycyclohexylmethyl)ether of ethylene glycol, ethylene-bis(3,4-epoxycyclohexane carboxylate), dioctyl epoxyhexahydrophthalate, di-2-ethylhexyl epoxyhexahydrophthalate, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ethers, 1,1,3-tetradecadiene dioxide, limonene dioxide, 1,2,7,8-diepoxyoctane and 1,2,5,6-diepoxycyclooctane.

Among these epoxy compounds, an aromatic epoxide and an alicyclic epoxide are preferred in view of excellent curing rate, and an alicyclic epoxide is more preferred.

Examples of the vinyl ether compound include a di- or trivinyl ether compound such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether and trimethylolpropane trivinyl ether; and a monovinyl ether compound such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-O-propylene carbonate, dodecyl vinyl ether, diethylene glycol monovinyl ether and octadecyl vinyl ether.

The vinyl ether compound may be monofunctional or polyfunctional.

Specifically, examples of the monofunctional vinyl ether include methyl vinyl ether, ethyl vinyl ether, propyl vinyl ether, n-butyl vinyl ether, tert-butyl vinyl ether, 2-ethylhexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether and phenoxypolyethylene glycol vinyl ether.

Examples of the polyfunctional vinyl ether include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ether and bisphenol F alkylene oxide divinyl ether; and polyfunctional vinyl ethers such as trimethylolethane trivinyl ether, trimethylolpropane trivinyl ether, ditrimethylolpropane tetravinyl ether, glycerin trivinyl ether, pentaerythritol tetravinyl ether, dipentaerythritol pentavinyl ether, dipentaerythritol hexavinyl ether, ethylene oxide-added trimethylolpropane trivinyl ether, propylene oxide-added trimethylolpropane trivinyl ether, ethylene oxide-added ditrimethylolpropane tetravinyl ether, propylene oxide-added ditrimethylolpropane tetravinyl ether, ethylene oxide-added pentaerythritol tetravinyl ether, propylene oxide-added pentaerythritol tetravinyl ether, ethylene oxide-added dipentaerythritol hexavinyl ether and propylene oxide-added dipentaerythritol hexavinyl ether.

As for the vinyl ether compound, a di- or trivinyl ether compound is preferred in view of curing property, adhesion to recording medium, surface hardness of image formed, or the like, and a divinyl ether compound is more preferred.

The oxetane compound as referred to in the present invention indicates a compound having an oxetane ring, and known oxetane compounds described, for example, in JP-A-2001-220526, JP-A-2001-310937 and JP-A-2003-341217 may be arbitrarily selected and used.

The compound having an oxetane ring, which can be used in the ink composition of the present invention; is preferably a compound having from one to four oxetane rings in the structure thereof. When such a compound is used, the viscosity of the ink composition can be easily maintained in the range allowing for good handling, and high adhesion can be obtained between the ink composition after curing and the recording medium.

Such a compound having an oxetane ring is described in detail in paragraphs [0021] to [0084] of JP-A-2003-341217, and compounds described therein can be suitably used also in the present invention.

Out of the oxetane compounds for use in the present invention, a compound having one oxetane ring is preferably used in view of viscosity and tackiness of the ink composition.

In the ink composition of the present invention, one of these cationic polymerizable compounds may be used alone, or two or more species thereof may be used in combination, but from the standpoint of effectively controlling the shrinkage on curing the ink, at least one compound selected from oxetane compounds and epoxy compounds is preferably used in combination with a vinyl ether compound.

The content of the (a) cationic polymerizable compound in the ink composition is suitably from 10 to 95 mass %, preferably from 30 to 90 mass %, more preferably from 50 to 85 mass %, based on the entire solid content of the composition.

(b) (Compound Capable of Generating an Acid Upon Irradiation with Active Energy)

The ink composition of the present invention contains a compound capable of generating an acid upon irradiation with active energy (hereinafter appropriately referred to as a “photoacid generator”).

The photoacid generator which can be used in the present invention may be appropriately selected from compounds capable of generating an acid upon irradiation with light (ultraviolet ray or far ultraviolet ray of 400 to 200 nm, preferably g-ray, h-ray, i-ray or KrF excimer laser light), ArF excimer laser light, electron beam, X-ray, molecular beam or ion beam, which are used in a photo-cationic polymerization photoinitiator, a photo-radical polymerization photoinitiator, a photo-decolorizing agent for coloring matters, a photo-discoloring agent, a micro resist or the like.

Examples of such a photoacid generator include an onium salt which decomposes upon irradiation with active energy to generate an acid, such as diazonium salt, ammonium salt, phosphonium salt, iodonium salt, sulfonium salt, selenonium salt and arsonium salt; an organic halogen compound; an organic metal/organic halide; an o-nitrobenzyl type protective group-containing photoacid generator; a compound capable of undergoing photodecomposition to generate a sulfonic acid, as represented by imino sulfonate; a disulfone compound; a diazoketosulfone; and a diazodisulfone compound.

Furthermore, for example, oxazole derivatives and s-triazine derivatives described in paragraphs [0029] to [0030] of JP-A-2002-122994 may also be suitably used as the photoacid generator. In addition, onium salt compounds and sulfonate-based compounds described in paragraphs [0037] to [0063] of JP-A-2002-122994 may also be suitably used as the photoacid generator in the present invention.

As for the (b) photoacid generator, one species may be used alone or two or more species may be used in combination.

The content of the (b) photoacid generator in the ink composition is preferably from 0.1 to 20 mass %, more preferably from 0.5 to 10 mass %, still more preferably from 1 to 7 mass %, based on the entire solid content of the ink composition.

### (Colorant)

The ink composition of the present invention can form a visible image by adding thereto a colorant. For example, in the case of forming an image region of a lithographic printing plate, a colorant need not be necessarily added, but in view of suitability for plate inspection of the obtained lithographic printing plate, use of a colorant is also preferred.

The colorant which can be used here is not particularly limited, and various known coloring materials (pigment, dye) may be appropriately selected and used according to the usage. For example, in the case of forming an image with excellent weather resistance, a pigment is preferred. As for the dye, both a water-soluble dye and an oil-soluble dye may be used, but an oil-soluble dye is preferred.

### (Pigment)

The pigment which is preferably used in the present invention is described below.

The pigment is not particularly limited and, for example, all organic and inorganic pigments generally available on the market, those obtained by dispersing a pigment in a dispersion medium such as insoluble resin, and those obtained by grafting a resin to the pigment surface may be used. In addition, those obtained by, for example, dyeing a resin particle with a dye may also be used.

Examples of such a pigment include pigments described in Seishiro Ito (compiler), Ganryo No Jiten (Pigment Dictionary), published in 2000, W. Herbst and K. Hunger, Industrial Organic Pigments, JP-A-2002-12607, JP-A-2002-188025, JP-A-2003-26978 and JP-A-2003-342503.

Specific examples of the organic and inorganic pigments which can be used in the present invention are as follows. Examples of the pigment which provides a yellow color include a monoazo pigment such as C.I. Pigment Yellow 1 (e.g., Fast Yellow G) and C.I. Pigment Yellow 74; a disazo pigment such as C.I. Pigment Yellow 12 (e.g., Disazo Yellow AAA) and C.I. Pigment Yellow 17; anon-benzidine-based azo pigment such as C.I. Pigment Yellow 180; an azo lake pigment such as C.I. Pigment Yellow 100 (e.g., Tartrazine Yellow Lake); a condensed azo pigment such as C.I. Pigment Yellow 95 (e.g., Condensed Azo Yellow GR); an acidic dye lake pigment such as C.I. Pigment Yellow 115 (e.g., Quinoline Yellow Lake); a basic dye lake pigment such as C.I. Pigment Yellow 18 (e.g., Thioflavine Lake); an anthraquinone-based pigment such as Flavanthrone Yellow (Y-24); an isoindolinone pigment such as Isoindolinone Yellow 3RLT (Y-110); a quinophthalone pigment such as Quinophthalone Yellow (Y-138); an isoindoline pigment such as Isoindoline Yellow (Y-139); a nitroso pigment such as C.I. Pigment Yellow 153 (e.g., Nickel Nitroso Yellow); and a metal complex salt azomethine pigment such as C.I. Pigment Yellow 117 (e.g., Copper Azomethine Yellow).

Examples of the pigment which provides a red or magenta color include a monoazo-based pigment such as C.I. Pigment Red 3 (e.g., Toluidine Red); a disazo pigment such as C.I. Pigment Red 38 (e.g., Pyrazolone Red B); an azo lake pigment such as C.I. Pigment Red 53:1 (e.g., Lake Red C) and C.I. Pigment Red 57:1 (Brilliant Carmine 6B); a condensed azo pigment such as C.I. Pigment Red 144 (e.g., Condensed Azo Red BR); an acidic dye lake pigment such as C.I. Pigment Red 174 (e.g., Phloxine B Lake); a basic dye lake pigment such as C.I. Pigment Red 81 (e.g., Rhodamine 6G′ Lake); an anthraquinone-based pigment such as C.I. Pigment Red 177 (e.g., Dianthraquinonyl Red); a thioindigo pigment such as C.I. Pigment Red 88 (e.g., Thioindigo Bordeaux); a perinone pigment such as C.I. Pigment Red 194 (e.g., Perinone Red); a perylene pigment such as C.I. Pigment Red 149 (e.g., Perylene Scarlet); a quinacridone pigment such as C.I. Pigment Violet 19 (unsubstituted quinacridone) and C.I. Pigment Red 122 (e.g., Quinacridone Magenta); an isoindolinone pigment such as C.I. Pigment Red 180 (e.g., Isoindolinone Red 2BLT); and an alizarin lake pigment such as C.I. Pigment Red 83 (e.g., Madder Lake).

Examples of the pigment which provides a blue or cyan color include a disazo-based pigment such as C.I. Pigment Blue 25 (e.g., Dianisidine Blue); a phthalocyanine pigment such as C.I. Pigment Blue 15 (e.g., Phthalocyanine Blue); an acidic dye lake pigment such as C.I. Pigment Blue 24 (e.g., Peacock Blue Lake); a basic dye lake pigment such as C.I. Pigment Blue 1 (e.g., Victoria Pure Blue BO Lake); an anthraquinone-based pigment such as C.I. Pigment Blue 60 (e.g., Indanthrone Blue); and an alkali blue pigment such as C.I. Pigment Blue 18 (Alkali Blue V-5:1).

Examples of the pigment which provides a green color include a phthalocyanine pigment such as C.I. Pigment Green 7 (Phthalocyanine Green) and C.I. Pigment Green 36 (Phthalocyanine Green); and an azo metal complex pigment such as C.I. Pigment Green 8 (Nitroso Green).

Examples of the pigment which provides an orange color include an isoindoline-based pigment such as C.I. Pigment Orange 66 (Isoindoline Orange); and an anthraquinone-based pigment such as C. I. Pigment Orange 51 (Dichloropyranthrone Orange).

Examples of the pigment which provides a black color include carbon black, titanium black and aniline black.

Specific examples of the white pigment which can be used include basic lead carbonate (2PbCO₃Pb(OH)₂, so-called “silver white”) , zinc oxide (ZnO, so-called “zinc white”), titanium oxide (TiO₂, so-called “titanium white”), strontium titanate (SrTiO₃, so-called “titanium strontium white”).

Here, titanium oxide has a low specific gravity and a high refractive index and is chemically and physically stable as compared with other white pigments and therefore, this pigment ensures that the masking power and coloring power as a pigment are high and the durability against acid, alkali and other environments is excellent. Because of this, titanium oxide is preferably used as the white pigment. As a matter of course, other white pigments (may also be a white pigment other than those described above) may be used, if desired.

The pigment may be dispersed by using a dispersing device such as ball mill, sand mill, attritor, roll mill, jet mill, homogenizer, paint shaker, kneader, agitator, Henschel mixer, colloid mill, ultrasonic homogenizer, pearl mill and wet jet mill.

When dispersing the pigment, a dispersant may also be added. Examples of the dispersant include a hydroxyl group-containing carboxylic acid ester, a salt of long-chain polyaminoamide with high molecular weight acid ester, a salt of high molecular weight polycarboxylic acid, a high molecular weight unsaturated acid ester, a polymer copolymerization product, a modified polyacrylate, an aliphatic polyvalent carboxylic acid, a naphthalenesulfonic acid formalin condensate, a polyoxyethylene alkylphosphoric ester and a pigment derivative. A commercially available polymer dispersant such as Solsperse Series of Zeneca Ltd. may also be preferably used.

In addition, a synergist according to various pigments may be used as a dispersion aid. The dispersant or dispersion aid is preferably added in an amount of 1 to 50 parts by mass per 100 parts by mass of the pigment.

In the ink composition, a solvent may be added as a dispersion medium for various components such as pigment, or the (a) cationic polymerizable compound which is a low molecular weight component may be used as a dispersion medium without using a solvent. However, since the ink composition of the present invention is an active energy-curable ink and the ink is applied onto a recording medium and then cured, the ink composition is preferably solvent-free. This is because when a solvent remains in the cured ink image, the solvent resistance may deteriorate or the residual solvent may cause a problem of VOC (volatile organic compound). From such a standpoint, the (a) cationic polymerizable compound is preferably used as the dispersion medium. Above all, in view of dispersion suitability or enhancement of handling property of the ink composition, a cationic polymerizable monomer having a lowest viscosity is preferably selected.

The average particle diameter of the pigment is preferably from 0.02 to 4 μm, more preferably from 0.02 to 2 μm, still more preferably from 0.02 to 1.0 μm.

The pigment, dispersant, dispersion medium and dispersion or filtration conditions are selected or set so that the pigment particle can have an average particle diameter in the above-described preferred range. By this control of the particle diameter, clogging of the head nozzle can be suppressed and the storage stability, transparency and curing sensitivity of ink can be maintained.

### (Dye)

The dye for use in the present invention is preferably an oil-soluble dye. Specifically, the oil-soluble dye means a dye having a solubility in water at 25° C. (mass of the coloring matter dissolved in 100 g of water) of 1 g or less. The solubility is preferably 0.5 g or less, more preferably 0.1 g or less. Accordingly, a so-called water-insoluble oil-soluble dye is preferably used.

As regards the dye for use in the present invention, it is also preferred to introduce an oil-solubilizing group into the mother nucleus of the above-described dye for the purpose of dissolving a necessary amount of dye in the ink composition.

Examples of the oil-solubilizing group include a long-chain or branched alkyl group, a long-chain or branched alkoxy group, a long-chain or branched alkylthio group, a long-chain or branched alkylsulfonyl group, a long-chain or branched acyloxy group, a long-chain or branched alkoxycarbonyl group, a long-chain or branched acyl group, a long-chain or branched acylamino group, a long-chain or branched alkylsulfonylamino group, a long-chain or branched alkylaminosulfonyl group; and an aryl group, an aryloxy group, an aryloxycarbonyl group, an arylcarbonyloxy group, an arylaminocarbonyl group, an arylaminosulfonyl group and an arylsulfonylamino group, each containing the above-described long-chain or branched substituent.

Furthermore, the dye may be obtained from a water-soluble dye having a carboxyl acid or a sulfonic acid through conversion into an oil-solubilizing group, that is, an alkoxycarbonyl group, an aryloxycarbonyl group, an alkylaminosulfonyl group or an arylaminosulfonyl group, by using a long-chain or branched alcohol, an amine, a phenol or an aniline derivative.

The oil-soluble dye preferably has a melting point of 200° C. or less, more preferably 150° C. or less, still more preferably 100° C. By using an oil-soluble dye having a low melting point, crystal precipitation of the coloring matter in the ink composition is suppressed and the ink composition comes to have good storage stability.

Furthermore, for the purpose of improving resistance against fading, particularly against an oxidative substance such as ozone, or enhancing the curing property, the oxidation potential is preferably noble (high). For this reason, the oil-soluble dye for use in the present invention preferably has an oxidation potential of 1.0V (vs SCE) or more. A higher oxidation potential is preferred, and the oxidation potential is more preferably 1.1 V (vs SCE) or more, still more preferably 1.15 V (vs SCE) or more.

As for the dye of yellow color, compounds having a structure represented by formula (Y-I) of JP-A-2004-250483 are preferred.

Dyes represented by formulae (Y-II) to (Y-IV) described in paragraph [0034] of JP-A-2004-250483 are more preferred. Specific examples thereof include compounds described in paragraphs [0060] to [0071] of JP-A-2004-250483. Incidentally, the oil-soluble dye of formula (Y-I) described in the patent publication above may be used not only for yellow ink but also for ink of any color, such as black ink and red ink.

As for the dye of magenta color, compounds having a structure represented by formula (3) or (4) described in JP-A-2002-114930 are preferred. Specific examples thereof include the compounds described in paragraphs [0054] to [0073] of JP-A-2002-114930.

Azo dyes represented by formulae (M-1) to (M-2) described in paragraphs [0084] to [0122] of JP-A-2002-121414 are more preferred, and specific examples thereof include the compounds described in paragraphs [0123] to [0132] of JP-A-2002-121414. Incidentally, the oil-soluble dyes of formulae (3), (4) and (M-1) to (M-2) described in these patent publications may be used not only for magenta ink but also for ink of any color, such as black ink and red ink.

As for the dye of cyan color, dyes represented by formulae (I) to (IV) of JP-A-2001-181547 and dyes represented by formulae (IV-1) to (IV-4) described in paragraphs [0063] to [0078] of JP-A-2002-121414 are preferred. Specific examples thereof include the compounds described in paragraphs [0052] to [0066] of JP-A-2001-181547 and the compounds described in paragraphs [0079] to [0081] of JP-A-2002-121414.

Phthalocyanine dyes represented by formulae (C-I) and (C-II) described in paragraphs [0133] to [0196] of JP-A-2002-121414 are more preferred, and the phthalocyanine dye represented by formula (C-II) is still more preferred. Specific examples thereof include the compounds described in paragraphs [0198] to [0201] of JP-A-2002-121414. Incidentally, the oil-soluble dyes of formulae (I) to (IV), (IV-1) to (IV-4), (C-I) and (C-II) may be used not only for cyan ink but also for ink of any color, such as black ink and green ink.

Such a colorant is preferably added in an amount of, in terms of the solid content, from 1 to 20 mass %, more preferably from 2 to 10 mass %, based on the ink composition.

In the ink composition of the present invention, in addition to the above-described essential components, various additives may be used in combination according to the purpose. These arbitrary components are described below.

### (Ultraviolet Absorbent)

In the present invention, an ultraviolet absorbent may be used from the standpoint of giving an image enhanced in the weather resistance and prevented from fading.

Examples of the ultraviolet absorbent include benzotriazole-based compounds described in JP-A-58-185677, JP-A-61-190537, JP-A-2-782, JP-A-5-197075 and JP-A-9-34057; benzophenone-based compounds described in JP-A-46-2784, JP-A-5-194483 and U.S. Pat. No. 3,214,463; cinnamic acid-based compounds described in JP-B-48-30492 (the term “JP-B” as used herein means an “examined Japanese patent application”) , JP-B-56-21141 and JP-A-10-88106; triazine-based compounds described in JP-A-4-298503, JP-A-8-53427, JP-A-8-239368, JP-A-10-182621 and JP-T-8-501291 (the term (the term “JP-T” as used herein means a “published Japanese translation of a PCT patent application”); compounds described in Research Disclosure, No. 24239; and compounds capable of absorbing ultraviolet ray to emit fluorescence, so-called fluorescent brightening agent, as represented by a stilbene-based compound and a benzoxazole-based compound.

The amount of the ultraviolet absorbent added is appropriately selected according to the purpose but is generally on the order of 0.5 to 15 mass % in terms of the solid content.

### (Sensitizer)

In the ink composition of the present invention, if desired, a sensitizer may be added for the purpose of enhancing the acid generation efficiency of the photoacid generator and shifting the photosensitive wavelength to a long wavelength side. The sensitizer may be any sensitizer as long as it can sensitize the photoacid generator by an electron or energy transfer mechanism. Preferred examples thereof include an aromatic polycondensed ring compound such as anthracene, 9,10-dialkoxyanthracene, pyrene and perylene; an aromatic ketone compound such as acetophenone, benzophenone, thioxanthone and Michler's ketone; and a heterocyclic compound such as phenothiazine and N-aryloxazolidinone. The amount of the sensitizer added is appropriately selected according to the purpose but is generally from 0.01 to 1 mol %, preferably from 0.1 to 0.5 mol %, based on the photoacid generator.

### (Antioxidant)

An antioxidant may be added for the purpose of enhancing the stability of the ink composition. Examples of the antioxidant include those described in EP-A-223739, EP-A-309401, EP-A-309402, EP-A-310551, EP-A-310552, EP-A-459416, German Unexamined Patent Publication No. 3435443, JP-A-54-48535, JP-A-62-262047, JP-A-63-113536, JP-A-63-163351, JP-A-2-262654, JP-A-2-71262, JP-A-3-121449, JP-A-5-61166, JP-A-5-119449, and U.S. Pat. Nos. 4,814,262 and 4,980,275.

The amount of the antioxidant added is appropriately selected according to the purpose but is generally on the order of 0.1 to 8 mass % in terms of the solid content.

### (Anti-Fading Agent)

In the ink composition of the present invention, various organic or metal complex-based anti-fading agents may be used. Examples of the organic anti-fading agent include hydroquinones, alkoxyphenols, dialkoxyphenols, phenols, anilines, amines, indanes, chromans, alkoxyanilines and heterocyclic compounds. Examples of the metal complex-based anti-fading agent include a nickel complex and a zinc complex, and specifically, there may be used the compounds described in patents cited in Research Disclosure, No. 17643, No. VII, Items I to J, ibid., No. 15162, ibid., No, 18716, page 650, left column, ibid., No. 36544, page 527, ibid., No. 307105, page 872, and ibid., No. 15162; and the compounds included in formulae of representative compounds and in examples of the compounds describe on JP-A-62-215272, pp. 127-137.

The amount of the anti-fading agent added is appropriately selected according to the purpose but is generally on the order of 0.1 to 8 mass % in terms of the solid content.

### (Electrically Conducting Salts)

In the ink composition of the present invention, electrically conducting salts such as potassium thiocyanate, lithium nitrate, ammonium thiocyanate and dimethylamine hydrochloride may be added for the purpose of controlling the ejection physical property.

### (Solvent)

In the ink composition of the present invention, addition of an organic solvent in an extremely small amount is also effective for the purpose of improving the adhesion to a recording medium.

Examples of the solvent include a ketone-based solvent such as acetone, methyl ethyl ketone and diethyl ketone; an alcohol-based solvent such as methanol, ethanol, 2-propanol, 1-propanol, 1-butanol and tert-butanol; a chlorine-based solvent such as chloroform and methylene chloride; an aromatic solvent such as benzene and toluene; an ester-based solvent such as ethyl acetate, butyl acetate and isopropyl acetate; an ether-based solvent such as diethyl ether, tetrahydrofuran and dioxane; and a glycol ether-based solvent such as ethylene glycol monomethyl ether and ethylene glycol dimethyl ether.

In this case, addition in the range of not causing a problem in the solvent resistance or VOC is effective, and this amount is preferably from 0.1 to 5 mass %, more preferably from 0.1 to 3 mass %, based on the entire ink composition.

### (Polymer Compound)

In the ink composition of the present invention, various polymer compounds may be added for the purpose of adjusting the film physical properties. Examples of the polymer compound which can be used include an acryl-based polymer, a polyvinyl butyral resin, a polyurethane resin, a polyamide resin, a polyester resin, an epoxy resin, a phenol resin, a polycarbonate resin, a polyvinyl butyral resin, a polyvinyl formal resin, a shellac, a vinyl-based resin, an acryl-based resin, a rubber-based resin, waxes and other natural resins. Also, two or more species thereof may be used in combination. Among these, a vinyl-based copolymer obtainable by the copolymerization of an acryl-based monomer is preferred. In addition, as for the copolymerization composition of the polymer binder, a copolymer containing, as the structural unit, a “carboxyl group-containing monomer”, an “alkyl methacrylate” or an “alkyl acrylate” is also preferably used.

### (Surfactant)

In the ink composition of the present invention, a surfactant may also be added.

The surfactant includes those described in JP-A-62-173463 and JP-A-62-183457, Examples thereof include an anionic surfactant such as dialkylsulfosuccinates, alkylnaphthalenesulfonates and fatty acid salts; a nonionic surfactant such as polyoxyethylene alkyl ethers, polyoxyethylene alkylallyl ethers, acetylene glycols and polyoxyethylene-polyoxypropylene block copolymers; and a cationic surfactant such as alkylamine salts and quaternary ammonium salts. Incidentally, an organic fluoro compound may be used in place of the surfactant above. The organic fluoro compound is preferably hydrophobic. Examples of the organic fluoro compound include a fluorine-containing surfactant, an oily fluorine-containing compound (e.g., fluorine oil), a solid fluorine compound resin (e.g., tetrafluoroethylene resin), and those described in JP-B-57-9053 (columns 8 to 17) and JP-A-62-135826.

Other than these, for example, a leveling additive, a matting agent, waxes for adjusting the film physical properties, and a tackifier for improving adhesion to a recording medium such as polyolefin and PET, which does not inhibit the polymerization, may be added, if desired.

Specific examples of the tackifier include high molecular weight adhesive polymers described in JP-A-2001-49200, pp. 5-6 (for example, a copolymer comprising an ester of a (meth)acrylic acid and an alcohol containing an alkyl group having a carbon number of 1 to 20, an ester of a (meth) acrylic acid and an alicyclic alcohol having a carbon number of 3 to 14, or an ester of a (meth)acrylic acid and an aromatic alcohol having a carbon number of 6 to 14); and a low molecular weight tackifier resin having a polymerizable unsaturated bond.

### (Radical Polymerization-Type Ink Composition)

The radical polymerization-type ink composition contains (d) a radical polymerizable compound, (e) a polymerization initiator and a colorant and, if desired, may further contain a colorant, a sensitizing dye, a co-sensitizer and the like.

The constituent components used in the radical polymerization-type ink composition are described below in sequence.

(d) (Radical Polymerizable Compound)

The radical polymerizable compound includes, for example, the following compound having an addition-polymerizable ethylenically unsaturated bond.

### (Compound Having Addition-Polymerizable Ethylenically Unsaturated Bond)

Examples of the compound having an addition-polymerizable ethylenically unsaturated bond, which can be used in the ink composition of the present invention, include an ester of an unsaturated carboxylic acid (e.g., acrylic acid, methacrylic acid, itaconic acid, crotonic acid, isocrotonic acid, maleic acid) and an aliphatic polyhydric alcohol compound, and an amide of the above-described unsaturated carboxylic acid and an aliphatic polyvalent amine compound.

Specific examples of the ester monomer of an aliphatic polyhydric alcohol compound and an unsaturated carboxylic acid include the followings. Examples of the acrylic ester include ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, and polyester acrylate oligomer.

Examples of the methacrylic acid ester include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(acryloxyethoxy)phenyl]-dimethylmethane. Examples of itaconic acid ester include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of the crotonic acid ester include ethylene glycol dicrotonate, tetramethylene glycol dicrotonate, pentaerythritol dicrotonate, and sorbitol tetradicrotonate. Examples of the isocrotonic acid ester include ethylene glycol diisocrotonate, pentaerythritol diisocrotonate and sorbitol tetraisocrotonate. Examples of the maleic acid ester include ethylene glycol dimaleate, triethylene glycol dimaleate, pentaerythritol dimaleate and sorbitol tetramaleate. In addition, a mixture of these ester monomers may also be used. Specific examples of the amide monomer of an aliphatic polyvalent amine compound and an unsaturated carboxylic acid include methylenebis-acrylamide, methylenebis-methacrylamide, 1,6-hexamethylenebis-acrylamide, 1,6-hexamethylenebis-methacrylamide, diethylene triamine trisacrylamide, xylylenebisacrylamide, and xylylenebismethacrylamide.

Other examples include a vinyl urethane compound containing two or more polymerizable vinyl groups within one molecule, which is obtained by adding a hydroxyl group-containing vinyl monomer represented by the following formula (A) to a polyisocyanate compound containing two or more isocyanate groups within one molecule, described in JP-B-48-41708. CH₂═C(R)COOCH₂CH(R)OH (A) (wherein R and R′ each represents H or CH₃).

Still other examples include a functional acrylate or methacrylate such as urethane acrylates described in JP-A-51-37193, polyester acrylates described in JP-A-48-64183, JP-B-49-43191 and JP-B-52-30490, and epoxy acrylates obtained by reacting an epoxy resin and a (meth)acrylic acid. Furthermore, those described as a photocurable monomer or oligomer in Journal of the Adhesion Society of Japan, Vol. 20, No. 7, pp. 300-308 (1984) may also be used. In the present invention, these monomers can be used in a chemical form such as a prepolymer, namely, dimer, trimer or oligomer, or a mixture or copolymer thereof.

The amount of the radical polymerizable compound used is usually from 1 to 99.99%, preferably from 5 to 90.0%, more preferably from 10 to 70% (“%” as used herein indicates “mass %”), based on all components of the ink composition.

(e) (Photopolymerization Initiator)

The photopolymerization initiator for use in the radical polymerization-type ink composition of the present invention is described below.

The photopolymerization initiator as used in the present invention indicates a compound capable of undergoing a chemical change under the action of light or through interaction with the electron excited state of a sensitizing dye and thereby producing at least one species of a radical, an acid and a base.

Preferred examples of the photopolymerization initiator include (i) aromatic ketones, (ii) an aromatic onium salt compound, (iii) an organic peroxide, (iv) a hexaarylbiimidazole compound, (v) a ketoxime ester compound, (vi) a borate compound, (vii) an azinium compound, (viii) a metallocene compound, (vix) an active ester compound, and (x) a carbon-halogen bond-containing compound.

### (Colorant)

A colorant the same as those described for the (c) colorant regarding the cationic polymerization-type ink composition may be utilized.
In the ink composition of the present invention, in addition to the above-described essential components, various additives may be used in combination according to the purpose. These arbitrary components are described below.

### (Sensitizing Dye)

In the present invention, a sensitizing dye may be added for the purpose of improving the sensitivity of the photopolymerization initiator. Preferred examples of the sensitizing dye include those belonging to the following compounds and having an absorption wavelength in the region from 350 to 450 nm.

That is, the compounds are polynuclear aromatics (e.g., pyrene, perylene, triphenylene), xanthenes (e.g., fluorescein, eosin, erythrosin, Rhodamine B, Rose Bengale), cyanines (e.g., thiacarbocyanine, oxacarbocyanine), merocyanines (e.g., merocyanine, carbomerocyanine), thiazines (e.g., thionine, Methylene Blue, Toluidine Blue), acridines (e.g., Acridine Orange, chloroflavin, acriflavine), anthraquinones (e.g., anthraquinone), squaryliums (e.g., squarylium), and coumarins (e.g., 7-diethylamino-4-methylcoumarin).

### (Co-Sensitizer)

Furthermore, in the ink of the present invention, a known compound having an activity of, for example, more enhancing the sensitivity or suppressing the polymerization inhibition by oxygen may be added as a co-sensitizer.

Examples of such a co-sensitizer include amines such as compounds described in M. R. Sander, et al., Journal of Polymer Society, Vol. 10, page 3173 (1972), JP-B-44-20189, JP-A-51-82102, JP-A-52-134692, JP-A-59-138205, JP-A-60-84305, JP-A-62-18537, JP-A-64-33104, and Research Disclosure, No. 33825. Specific examples thereof include triethanolamine, ethyl p-dimethylaminobenzoate, p-formyldimethylaniline and p-methylthiodimethylaniline.

Other examples include thiols and sulfides such as thiol compounds described in JP-A-53-702, JP-B-55-500806, and JP-A-5-142772 and disulfide compounds described in JP-A-56-75643. Specific examples thereof include 2-mercaptobenzothiazole, 2-mercaptobenzoxazole, 2-mercaptobenzimidazole, 2-mercapto-4(3H)-quinazoline and β-mercaptonaphthalene.

Still other examples include an amino acid compound (e.g., N-phenylglycine), organometallic compounds described in JP-B-48-42965 (e.g., tributyltin acetate), hydrogen donors described in JP-B-55-34414, sulfur compounds described in JP-A-6-308727 (e.g., trithian), phosphorus compounds described in JP-A-6-250387 (e.g., diethyl phosphate), and Si—H and Ge—H compounds described in Japanese Patent Application No. 6-191605.

Also, in view of enhancing the storability, a polymerization inhibitor is preferably added in an amount of 200 to 20,000 ppm. The ink for inkjet recording of the present invention is preferably ejected after heating it in the range from 40 to 80° C. and thereby decreasing the viscosity, and also for preventing head clogging due to thermal polymerization, addition of a polymerization inhibitor is preferred. Examples of the polymerization inhibitor include hydroquinone, benzoquinone, p-methoxyphenol, TEMPO, TEMPOL and cupferron Al.

### (Others)

In addition, known compounds may be used as needed. For example, a surfactant, a leveling additive, a matting agent and, for adjusting the film physical properties, a polyester-based resin, a polyurethane-based resin, a vinyl-based resin, an acryl-based resin, a rubber-based resin or waxes, may be appropriately selected and used. Furthermore, in order to improve the adhesion to a recording medium such as polyolefin and PET, a tackifier which does not inhibit the polymerization is also preferably contained. Specific examples thereof include high molecular weight adhesive polymers described in JP-A-2001-49200, pp. 3-6 (for example, a copolymer comprising an ester of a (meth) acrylic acid and an alcohol containing an alkyl group having a carbon number of 1 to 20, an ester of a (meth)acrylic acid and an alicyclic alcohol having a carbon number of 3 to 14, or an ester of a (meth)acrylic acid and an aromatic alcohol having a carbon number of 6 to 14); and a low molecular weight tackifier resin having a polymerizable unsaturated bond.

Also, addition of an organic solvent in an extremely small amount is effective for the purpose of improving adhesion to a recording medium. In this case, addition in the range of not causing a problem in the solvent resistance or VOC is effective, and this amount is preferably from 0.1 to 5 mass %, more preferably from 0.1 to 3 mass %, based on the entire ink composition.

Furthermore, as the means for preventing reduction in the sensitivity due to light-shielding effect of the coloring material in the ink, it is also one preferred embodiment to form a radical/cation hybrid-type curing ink by combining a cationic polymerizable monomer having a long life as the polymerization initiator with a polymerization initiator.

### (Aqueous Ink Composition)

The aqueous ink composition contains a polymerizable compound and a water-soluble photopolymerization initiator capable of generating a radical under the action of active energy and if desired, may further contain a coloring material and the like.

### (Polymerizable Compound)

As for the polymerizable compound contained in the aqueous ink composition of the present invention, a polymerizable compound contained in known aqueous ink compositions may be used.

In the aqueous ink composition, a reactive material may be added so as to optimize the formulation by taking into account end user characteristics such as curing rate, adhesion and flexibility. For example, a (meth)acrylate (namely, acrylate and/or methacrylate) monomer or oligomer, an epoxide and an oxetane are used as such a reactive material.

Examples of the acrylate monomer include a phenoxyethyl acrylate, an octyldecyl acrylate, a tetrahydrofuryl acrylate, an isobornyl acrylate, a hexanediol diacrylate, a trimethylolpropane triacrylate, a pentaerythritol triacrylate, a polyethylene glycol diacrylate (e.g., tetraethylene glycol diacrylate), a dipropylene glycol diacrylate, a tri(propylene glycol) triacrylate, a neopentyl glycol diacrylate, a bis(pentaerythritol) hexaacrylate, an acrylate of ethoxylated or propoxylated glycol and polyol (e.g., propoxylated neopentyl glycol diacrylate, ethoxylated trimethylolpropane triacrylate), and a mixture thereof.

Examples of the acrylate oligomer include an ethoxylated polyethylene glycol, an ethoxylated trimethylolpropane acrylate, a polyether acrylate including its ethoxylated product, and a urethane acrylate oligomer.

Examples of the methacrylate include a hexanediol dimethacrylate, a trimethylolpropane trimethacrylate, a triethylene glycol dimethacrylate, a diethylene glycol dimethacrylate, an ethylene glycol dimethacrylate, a 1,4-butanediol dimethacrylate, and a mixture thereof.

The amount of the oligomer added is preferably from 1 to 80 wt %, more preferably from 1 to 10 wt %, based on the entire weight of the ink composition.

### (Water-Soluble Photopolymerization Initiator Capable of Producing a Radical Under the Action of Active Energy)

The polymerization initiator which can be used in the ink composition of the present invention is described below. As one example, a photopolymerization initiator up to a wavelength of around 400 nm may be used. Examples of such a photopolymerization initiator include photopolymerization initiators represented by the following formulae, which are a substance having functionality in a long wavelength region, namely, sensitivity of producing a radical when irradiated with ultraviolet rays (hereinafter simply referred to as a “TX system”). In the present invention, particularly, a photopolymerization initiator appropriately selected from these is preferably used.

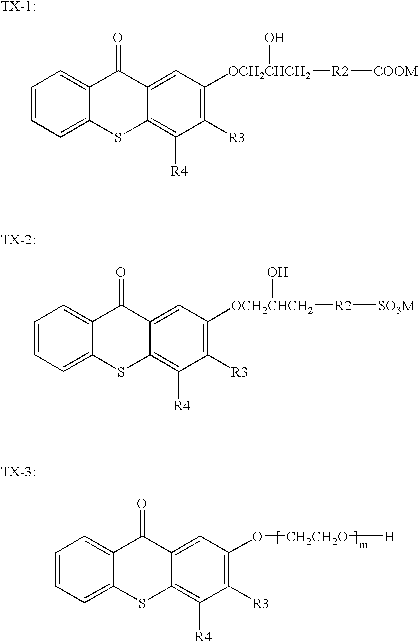

In formulae TX-1 to TX-3, R2 represents —(CH₂)ₓ— (wherein x is 0 or 1), —O—(CH₂)_{y}— (wherein y is 1 or 2), or a substituted or unsubstituted phenylene group. When R2 is a phenylene group, at least one of the hydrogen atoms in the benzene ring may be substituted by one group or atom or two or more groups or atoms selected from, for example, a carboxyl group or a salt thereof, a sulfonic acid or a salt thereof, a linear or branched alkyl group having a carbon number of 1 to 4, a halogen atom (e.g., fluorine, chlorine, bromine), an alkoxyl group having a carbon number of 1 to 4, and an aryloxy group such as phenoxy group. M represents a hydrogen atom or an alkali metal (e.g., Li, Na, K). R3 and R4 each independently represents a hydrogen atom or a substituted or unsubstituted alkyl group. Examples of the alkyl group include a linear or branched alkyl group having a carbon number of approximately from 1 to 10, particularly, a carbon number of approximately from 1 to 3. Examples of the substituent for this alkyl group include a halogen atom (e.g., fluorine, chlorine, bromine), a hydroxyl group, and an alkoxyl group (having a carbon number of approximately from 1 to 3) m represents an integer of 1 to 10.

In the present invention, a water-soluble derivative of a photopolymerization initiator, Irgacure 2959 (trade name, produced by Ciba Specialty Chemicals), represented by the following formula (hereinafter simply referred to as an “IC system”) may be used. Specifically, IC-1 to IC-3 of the following formulae may be used Formula:

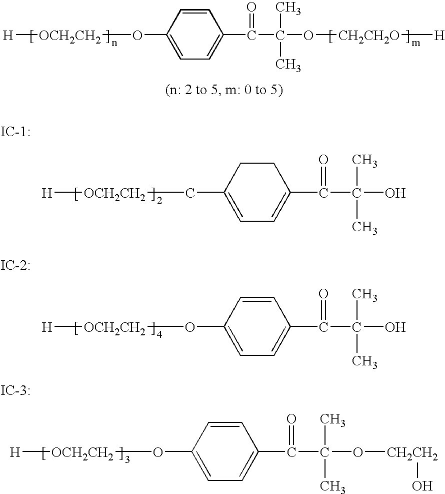

### (Formulation for Clear Ink)

By using the water-soluble polymerizable compound in the form of a transparent aqueous ink without incorporating the above-described coloring material, a clear ink can be prepared. In particular, when the ink is prepared to have inkjet recording property, an aqueous photocuring-type clear ink for inkjet recording is obtained. This ink contains no coloring material and therefore, a clear film can be obtained by using the ink. Examples of the usage of the coloring material-free clear ink include use as an undercoat for imparting suitability for image printing to a recording material, and use as an overcoat for protecting the surface of an image formed by a normal ink or further imparting decoration, gloss or the like. In the clear ink, a colorless pigment, a fine particle or the like not for the purpose of coloration may be incorporated by dispersion according to the usage above. By this addition, various properties such as image quality, fastness and processability (handling property) of a printed matter can be enhanced in both cases of undercoat and overcoat.

As for the formulation conditions in such application to a clear ink, the ink is preferably prepared to contain a water-soluble polymerizable compound as the main component of the ink in a proportion of 10 to 85% and a photopolymerization initiator (for example, an ultraviolet polymerization catalyst) in an amount of 1 to 10 parts by mass per 100 parts by mass of the water-soluble polymerizable compound and at the same time, contain a photopolymerization initiator in an amount of at least 0.5 parts per 100 parts of the ink.

### (Material Construction in Coloring Material-Containing Ink)

In the case of using the water-soluble polymerizable compound for a coloring material-containing ink, the concentrations of the polymerization initiator and polymerizable substance in the ink are preferably adjusted according to the absorption characteristics of the coloring material contained. As described above, the blending amount is set such that the amount of water or solvent is, on the mass basis, from 40 to 90%, preferably from 60 to 75%. Also, the content of the polymerizable compound in the ink is set to, on the mass basis, from 1 to 30%, preferably from 5 to 20%, based on the entire amount of the ink. The amount of the polymerization initiator depends on the content of the polymerizable compound but is generally, on the mass basis, from 0.1 to 7%, preferably from 0.3 to 5%, based on the entire amount of the ink.

In the case where a pigment is used as the coloring material of the ink, the concentration of the pure pigment portion in the ink is generally from 0.3 to 10 mass % based on the entire amount of the ink. The coloring power of the pigment depends on the dispersed state of pigment particles, but when the concentration is approximately from 0.3 to 1%, this is in the range of use as a light color ink, whereas the value exceeding the range above gives a concentration employed for normal coloration.

### (Preferred Physical Properties of Ink Composition)

Taking into account the ejection property, the ink composition of the present invention preferably has an ink viscosity of 20 mPa·s or less, more preferably 10 mPa·s or less, at the ejection temperature, and an appropriate compositional ratio is preferably determined to give an ink viscosity in this range.

The surface tension in common of the ink composition of the present invention is preferably from 20 to 40 mN/m, more preferably from 25 to 35 mN/m. In the case of recording an image on various recording mediums such as polyolefins, PET, coated paper and non-coated paper, the surface tension is preferably 20 mN/m or more in view of bleeding and penetration and is preferably 40 mN/m or less in view of wettability.

The thus-prepared ink composition of the present invention is suitably used as an ink for inkjet recording. In the case of using the ink composition as an ink for inkjet recording, the ink composition is ejected on a recording medium by an inkjet printer and the ink composition ejected is then cured by irradiating thereon active energy, whereby recording is performed.

The printed matter obtained using this ink has an image area cured by the irradiation of active energy such as ultraviolet ray and is assured of excellent strength of the image area and therefore, the ink composition can be used for various uses such as formation of an ink-receiving layer (image area) of a lithographic printing plate, other than the formation of an image.

The present application claims foreign priority based on Japanese Patent Application (JP 2006-269001) filed Sep. 29 of 2006, the contents of which is incorporated herein by reference.

What is claimed is:

1. An active energy curing-type inkjet recording apparatus comprising:
an inkjet head that ejects an active energy-curable ink to form an image on a recording medium;
an irradiating unit that includes a light source, and that irradiates an active energy ray from the light source to cure the active energy-curable ink ejected by the inkjet head;
an energy intensity measuring unit that measures an intensity value of the active energy ray irradiated on the recording medium; and
an irradiation condition control unit that controls an irradiation condition of the active energy ray on the recording medium on the basis of the intensity value measured by the energy intensity measuring unit after a passing of time to the extent of allowing the temperature of the irradiating unit to be stabilized at the start-up from lighting or rest of the irradiating unit.

2. The inkjet recording apparatus as claimed in claim 1,
wherein
the active energy ray is an ultraviolet ray, and
the energy intensity measuring unit comprises a light intensity measuring unit.

3. The inkjet recording apparatus as claimed in claim 2, wherein the light source of the irradiating unit comprises an ultrahigh-pressure mercury lamp.
